(19) United States
(12) Patent Application Publication
(10) Pub. No.: US 2018/0331652 A1
(43) Pub. Date: Nov. 15, 2018

(54) FOLDING PHOTOVOLTAIC PANEL

(71) Applicant: SunPower Corporation, San Jose, CA (US)

(72) Inventors: David OKAWA, San Bruno, CA (US); John Paul KAPLA, Mill Valley, CA (US); Brian WARES, San Francisco, CA (US); Laurence B. MACKLER, Corte Madera, CA (US); Tamir LANCE, Los Gatos, CA (US); Ryan REAGAN, Fremont, CA (US); Alexander F. KELLER, Boston, MA (US); Hikaru IWASAKA, New York, NY (US); Gabriela Elena BUNEA, San Jose, CA (US)

(21) Appl. No.: 15/976,414

(22) Filed: May 10, 2018

Related U.S. Application Data
(60) Provisional application No. 62/505,766, filed on May 12, 2017.
(60) Provisional application No. 62/578,164, filed on Oct. 27, 2017.
(60) Provisional application No. 62/635,437, filed on Feb. 26, 2018.

(51) Int. Cl. H02S 30/20; H02S 20/23

(52) U.S. Cl. CPC H02S 30/20; H02S 40/32; H02S 20/23

(57) ABSTRACT

A folding photovoltaic (PV) panel is described. The folding PV panel may include several subpanels interconnected by a hinge assembly. The hinge assembly may include a first section, a second section, and a third section between the first and second sections. The first section of the hinge assembly may couple to a first subpanel and the second section of the hinge assembly may couple to a second subpanel. The folding PV panel may include at least one electrical conductor extending from the first subpanel to the second subpanel. The at least one electrical conductor may be located in the hinge assembly or in a cabling assembly bridging a channel defined by edges of the first and second subpanels and the third section of the hinge assembly.

### CROSS-REFERENCE TO RELATED APPLICATIONS

This application claims the benefit of U.S. Provisional Application No. 62/505,766, filed on May 12, 2017, U.S. Provisional Application No. 62/578,164, filed on Oct. 27, 2017, and U.S. Provisional Application No. 62/635,437, filed on Feb. 26, 2018, the entire contents of each of which are hereby incorporated by reference herein.

### BACKGROUND

Photovoltaic (PV) cells, commonly known as solar cells, are well known devices for converting solar radiation into electrical energy. Generally, solar cells are fabricated on a semiconductor wafer or substrate using semiconductor processing techniques to form a p-n junction near a surface of the substrate. Solar radiation impinging on the surface of the substrate creates electron and hole pairs in the bulk of the substrate, which migrate to p-doped and n-doped regions in the substrate, thereby generating a voltage differential between the doped regions. The doped regions are coupled to metal contacts on the solar cell to direct an electrical current from the cell to an external circuit coupled thereto. Generally, an array of solar cells, each solar cell interconnected, is mounted on a common or shared platform to provide a PV panel. The PV panel can be mounted on a frame to provide a PV module. Several PV modules or module groups may be electrically coupled to an electrical power distribution network to form a PV system.

### BRIEF DESCRIPTION OF THE DRAWINGS

FIG. 1A illustrates a folding photovoltaic (PV) panel, in accordance with an embodiment of the present disclosure.

FIG. 1B illustrates a folding PV panel, in accordance with an embodiment of the present disclosure.

FIG. 1C illustrates a folding photovoltaic PV panel, in accordance with an embodiment of the present disclosure.

FIG. 2 illustrates a cross-sectional view, taken about line A-A of FIG. 1, of a subpanel of a folding PV panel, in accordance with an embodiment of the present disclosure.

FIG. 3 illustrates a cross-sectional view, taken about line B-B of FIG. 1, of several subpanels of a folding PV panel interconnected by a hinge, in accordance with an embodiment of the present disclosure.

FIG. 4 illustrates a perspective view of a folding PV panel in a folded configuration, in accordance with an embodiment of the present disclosure.

FIG. 5 illustrates a side view of a several folding PV panels in a folded configuration on a shipping pallet, in accordance with an embodiment of the present disclosure.

FIG. 6A illustrates a perspective view of a folding PV panel having a portrait orientation spread on a roof, in accordance with an embodiment of the present disclosure.

FIG. 6B illustrates a perspective view of a folding PV panel having a landscape orientation spread on a roof, in accordance with an embodiment of the present disclosure.

FIG. 7 illustrates a cross-sectional view, taken about line C-C of FIG. 6, of a folding PV panel mounted on a roof, in accordance with an embodiment of the present disclosure.

FIGS. 8A-8B illustrate alternative hinges interconnecting several subpanels of a folding PV panel, in accordance with an embodiment of the present disclosure.

FIG. 9 illustrates a cross-sectional view of a folding PV panel interconnected by a hinge assembly, in accordance with an embodiment of the present disclosure.

FIG. 10 illustrates a cross-sectional view of a folding PV panel interconnected by a hinge assembly that defines a channel with edges of subpanels, in accordance with an embodiment of the present disclosure.

FIG. 11 illustrates a top view of the folding PV panel of FIG. 10.

FIG. 12 illustrates a top view of subpanels of a folding PV panel interconnected by a hinge assembly with a plurality of discrete hinges coupled to a same side of the subpanels, in accordance with an embodiment of the present disclosure.

FIG. 13 illustrates a cross-section view of a ribbon joint of a folding PV panel with a ribbon embedded in an encapsulant material of a seam of a hinge assembly.

FIG. 14 illustrates a cross-section view of a ribbon joint of folding PV panel with an isolated ribbon.

FIG. 15A illustrates a cross-section view of another embodiment of a ribbon joint of a folding PV panel with a ribbon embedded in an encapsulant material of a seam of a hinge assembly.

FIG. 15B illustrates a cross-section view of another embodiment of a ribbon joint of a folding PV panel with a ribbon embedded in an encapsulant material of a seam of a hinge assembly

FIG. 15C illustrates a top view of a folding photovoltaic (PV) panel employing the ribbon joint of FIG. 15A.

FIG. 16A illustrates a cross-section view of yet another embodiment of a ribbon joint of a folding PV panel with a ribbon embedded in an encapsulant material of a seam of a hinge assembly.

FIG. 16B illustrates a top view of a folding photovoltaic (PV) panel employing the ribbon joint of FIG. 16A.

FIG. 16C illustrates a perspective view of the folding photovoltaic (PV) panel of FIG. 16B spread on a roof.

FIG. 17 illustrates a side view of a self-shingling PV module system as may be employed, according to some embodiments.

FIG. 18 illustrates side views of self-shingling PV module systems as may be employed, according to some embodiments.

FIG. 19 illustrates plan views of self-shingling PV module systems as may be employed, according to some embodiments.

FIG. 20 illustrates perspective views of a self-shingling PV module system and portions thereof as may be boxed and unboxed, according to some embodiments.

FIG. 21 illustrates a perspective view of a self-shingling PV module system as may be employed, according to some embodiments.

FIG. 22 illustrates a perspective view of a self-shingling PV module system having two rows of PV cell arrays as may be employed, according to some embodiments.

FIG. 23 illustrates a side elevational view of an inverter and cover with airflow of a self-shingling PV module system as may be employed, according to some embodiments.

FIGS. 24 and 25 illustrate a perspective view of self-shingling PV modules on the roof of a house as may be employed, according to some embodiments.

FIG. 26 illustrates a perspective view of self-shingling PV modules on the roof of a house as may be employed, according to some embodiments.

FIG. 27 illustrates a perspective view of self-shingling PV modules on the roof of a house as may be employed, according to some embodiments.

FIG. 28 illustrates a perspective view of self-shingling PV modules on the roof of a house as may be employed, according to some embodiments.

FIGS. 29-31 illustrate a perspective view of self-shingling PV modules on the roof of a house as may be employed, according to some embodiments.

FIG. 32 shows a side sectional-view of a seam joining two self-shingling PV modules as may be employed, according to some embodiments.

FIG. 33 shows a top view of multiple straps that may be employed to join two self-shingling PV modules as may be employed, according to some embodiments.

FIG. 34 shows a top view of a continuous seam joining two self-shingling PV modules as may be employed, according to some embodiments.

FIG. 35 shows a side sectional-view of a two-pillar adhesive seam joining two self-shingling PV modules as may be employed, according to some embodiments.

FIG. 36 shows a side sectional-view of a “K” seam joining two self-shingling PV modules as may be employed, according to some embodiments.

FIG. 37 shows a side sectional-view of an “H” seam joining two self-shingling PV modules as may be employed, according to some embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps.

“Configured To.” Various units or components may be described or claimed as “configured to” perform a task or tasks. In such contexts, “configured to” is used to connote structure by indicating that the units/components include structure that performs those task or tasks during operation. As such, the unit/component can be said to be configured to perform the task even when the specified unit/component is not currently operational (e.g., is not on/active). Reciting that a unit/circuit/component is “configured to” perform one or more tasks is expressly intended not to invoke 35 U.S.C. § 112, sixth paragraph, for that unit/component.

“First,” “Second,” etc. As used herein, these terms are used as labels for nouns that they precede, and do not imply any type of ordering (e.g., spatial, temporal, logical, etc.). For example, reference to a “first” subpanel does not necessarily imply that this subpanel is the first subpanel in a sequence; instead the term “first” is used to differentiate this subpanel from another subpanel (e.g., a “second” subpanel).

“Coupled”—The following description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically.

In addition, certain terminology may also be used in the following description for the purpose of reference only, and thus are not intended to be limiting. For example, terms such as “upper,” “lower,” “above,” “below,” “in front of,” and “behind” refer to directions in the drawings to which reference is made. Terms such as “front,” “back,” “rear,” “side,” “outboard,” “inboard,” “leftward,” and “rightward” describe the orientation and/or location of portions of a component, or describe the relative orientation and/or location between components, within a consistent but arbitrary frame of reference which is made clear by reference to the text and the associated drawings describing the component(s) under discussion. Such terminology may include the words specifically mentioned above, derivatives thereof, and words of similar import. “Inhibit”—As used herein, inhibit is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

Logistics, shipping, and labor costs involved in rooftop installation of existing photovoltaic (PV) modules are expensive. The frames and panels of existing PV modules are typically large and heavy, and thus, shipping the PV modules is expensive and handling the PV modules is cumbersome. In addition, logistics, shipping, transport, and installation of PV racking systems is expensive and time consuming. Removal or reduction of racking systems can substantially impact the cost and time to payback for PV systems.

In an aspect, a folding PV panel has two or more subpanels interconnected by one or more flexible regions (e.g., one or more hinges). The subpanels can be folded into a stacked configuration for shipment, which can decrease shipping costs and make handling of the folded subpanels easier. The folded subpanels can also enable easy transport of the panels from warehouses to job sites and from truck to roof. The folding PV panel can be lightweight and can be mounted directly on a roof. For example, direct roof attachment may be enabled by placing a power converter (e.g. a microinverter) on a front or back side of the folding PV panel, removing the frame, and/or by fabricating the folding PV panel from lightweight materials, e.g., polymers.

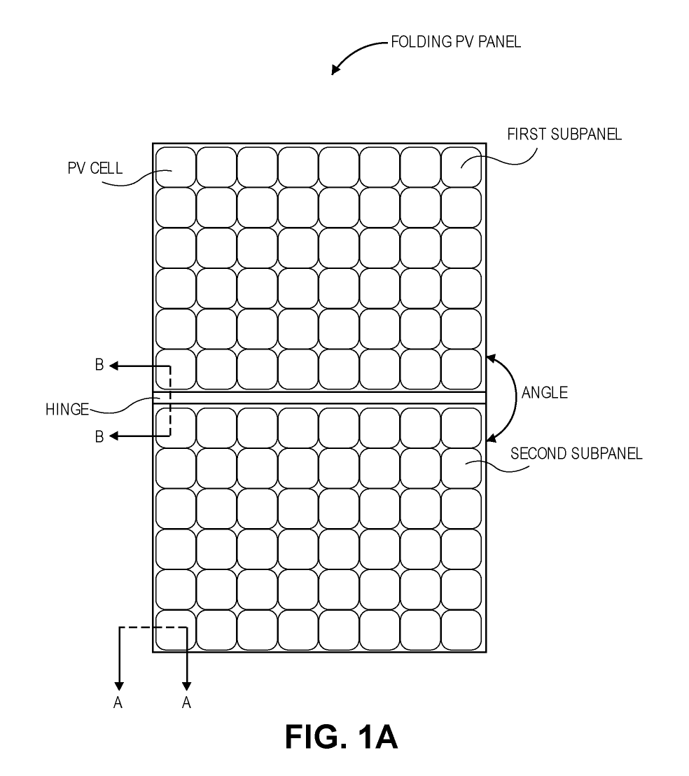

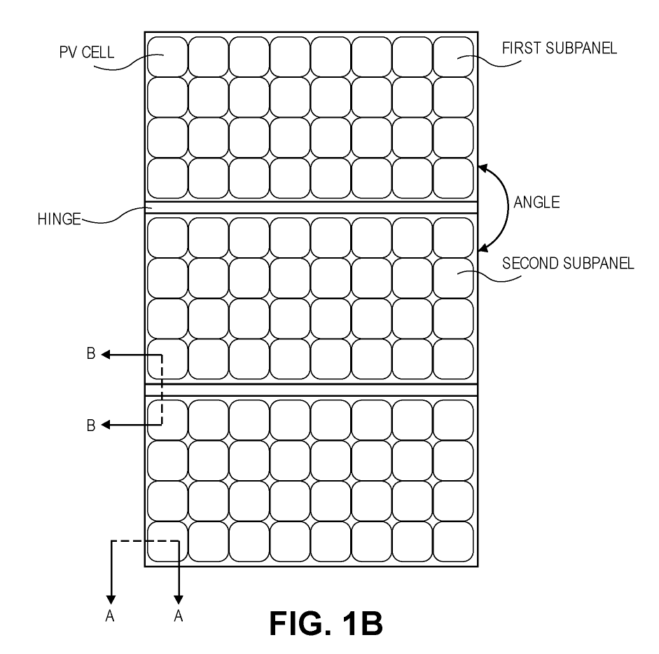

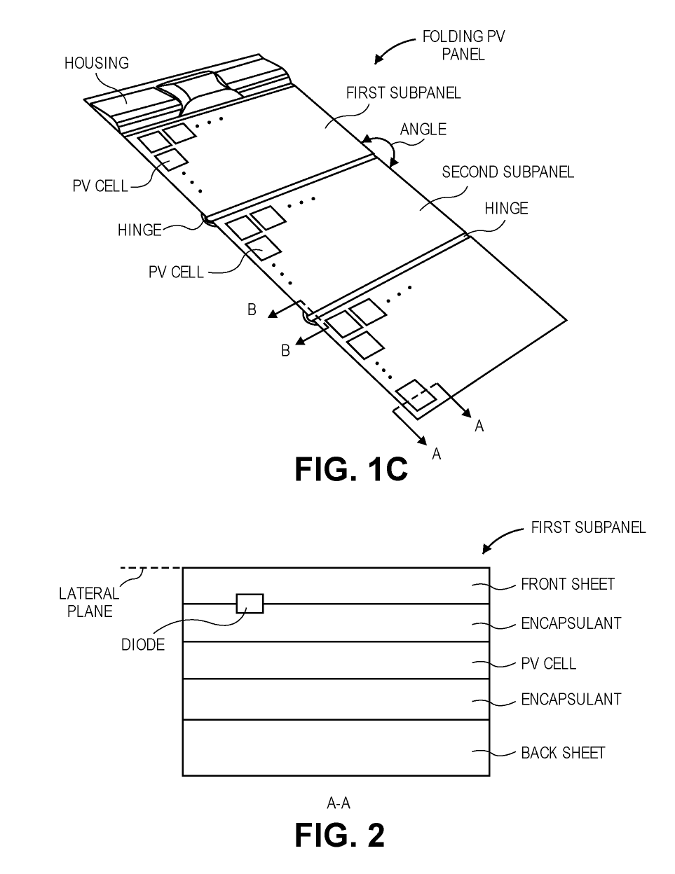

Referring to FIG. 1A-C, folding PV panels are shown in accordance with various embodiments of the present disclosure. Folding PV panels of the present disclosure can include two or more subpanels interconnected by one or more hinges. FIG. 1A depicts a dualfold folding PV panel with a single hinge. FIG. 1B depicts a trifold folding PV panel with two hinges. Any desirable number of subpanels and hinges can be employed (e.g., a quadfold folding PV panel with three hinges and so on). Sub panels may be made of materials with characteristics such as thickness and length and width appropriate to meet >40V, 600V, 1000V, or 1500V applications that may be grid tied. In one example, the width of a subpanel can be selected between 0.8-1.2 meters and the length of a subpanel can be selected to be 1-2.5 meters.

The folding PV panel may include a first subpanel having several PV cells arranged in an array to receive and convert sunlight into electrical energy. The folding PV panel may also include a second subpanel having respective PV cells arranged in an array. The array can include any number of rows and columns of PV cells. Furthermore, the folding PV panel can include any total number of PV cells, e.g., 50-150 total PV cells. For example, each subpanel of the folding PV panel depicted in FIG. 1A includes six rows and eight columns of PV cells. As another example, each subpanel of the folding PV panel depicted in FIG. 1B includes four rows and eight columns of PV cells. Only three PV cells are shown in the first subpanel and the second subpanel of FIG. 1C, however, it will be understood that each subpanel may include a complete array of PV cells.

The illustration of the cells of the first and second subpanels is not intended to be limiting—any subpanel described herein may include any type of cell (such as cells that are partially or wholly singulated and/or separated, for instance). In one example, monocrystalline, polycrystalline and/or any other type of silicon-based solar cell can be used. FIG. 1A-C depict PV subpanels comprising interdigitated back contact (IBC) solar cells, however front contact solar cells and/or shingled strips of solar cells can be employed. For example, shingled strips can be, e.g., cut from standard dimension silicon solar cells and joined together in an overlapping manner using conductive adhesive that connects strips to adjacent strips.

In an embodiment, each subpanel of the folding PV panel may include a front side facing the sun and a backside facing an installation site. For example, each PV subpanel may include a front sheet facing upward toward the sun, and a back sheet facing downward toward a roof. The back sheet of each subpanel may be mounted directly on the roof, as described below.

The front sheet and back sheet of the subpanels may be planar. The front sheet and back sheet may be flexible, semi-rigid, rigid or a combination thereof. More particularly, each of the subpanels may extend along a respective lateral plane. For example, the first PV subpanel may extend along a first lateral plane, and the second PV subpanel may extend along a second lateral plane. The lateral planes may be separated by an angle. For example, when the folding PV panel is folded about the hinge, the angle between the subpanels may change. By way of example, when the second subpanel is folded upward about the hinge, the angle between the front sheet of the first subpanel and the front sheet of the second subpanel decreases. The hinge permits the angle between the first lateral plane and the second lateral plane to change. Accordingly, each of the subpanels in the folding PV panel can be coupled to one or more adjacent subpanels by a respective hinge, and the hinges may be opened to spread the subpanels for mounting (FIG. 1A-C), or the hinges may be closed to stack the subpanels for shipment and handling (FIG. 4).

The folding PV panel may include other components mounted on the subpanels. In some embodiments, accessory components (e.g. module-level power electronics, mounting features, etc.) can be mounted on the back side of the subpanel(s) such that the accessory components are not visible from the front side for aesthetic purposes or otherwise (e.g. FIG. 1A-B). As another example, a housing may be mounted on the first subpanel. More particularly, the housing may be mounted on the front side of the first subpanel as depicted in FIG. 1C. Furthermore, the housing may be mounted over another component, e.g., an electrical or electronic component, of the folding PV panel. For example, the housing may be mounted over one or more of a power converter, dc-dc converter, microinverter or a junction box (not shown).

The microinverter or the junction box may be mounting on any surface of any of the panels. For instance, as described below, the microinverter or the junction box can be mounted on top of the first subpanel. In other embodiments, one of the microinverter or the junction box may be mounted on one subpanel (e.g., on the first subpanel, such as on a top or bottom of the first subpanel), and the other of the microinverter or the junction box may be mounted on the same or different side of a different subpanel (e.g., on the second subpanel, such as on a top or bottom of the second subpanel). Also, in some embodiments, a microinverter may be mounted on a single subpanel of a folding PV panel, and more than one junction box may be mounted, respectively, on more than one subpanel (e.g., one junction box on each subpanel, in some embodiments, to provide on subpanel with a microinverter and a junction box and one or more additional subpanels each having a junction box).

The folding PV panel is primarily described as an alternating current type PV panel herein, however, the folding PV panel may have a different panel architecture. For example, the folding PV panel may have a direct current (DC) panel architecture. Accordingly, other components may be mounted in the housing. For example, a DC optimizer may be mounted on a top surface of the first subpanel and may be enclosed within the housing.

In addition to housing an integrated microinverter, the housing may enclose electrical cables, e.g., alternating current or direct current cables, and connectors used to transfer electrical power between the PV cells and an electrical power distribution network. The housing can isolate and protect the various enclosed components from a surrounding environment. For example, the housing can provide a rain shield and flashing for water shedding. The housing may be a plastic or a metal enclosure having rounded edges, and may be colored to blend into an aesthetic of the roof on which the folding PV panel is mounted.

In an embodiment, the housing can include cabling management features. For example, the housing may include cable/connector or cabling management features built into or attached to the enclosure. The features may keep components raised. More particularly, the features may hold the components at a location that is spaced apart from the first subpanel, or from other surfaces that may come into contact with water.

Referring to FIG. 2, a cross-sectional view, taken about line A-A of FIGS. 1A-C, of a subpanel of a folding PV panel is shown in accordance with an embodiment of the present disclosure. Each subpanel, and optionally each hinge, of the folding PV panel, may have all-polymer constructions. The all-polymer construction of the subpanel may exclude the PV cells, electrical interconnects, etc. More particularly, the all-polymer construction may refer to the laminate layers of the subpanel. Or, at least one or more of a front sheet or a back sheet of each subpanel may be fabricated from polymer, such as for example, glass-filled polymer. Accordingly, the subpanels and the folding PV panel may be lightweight.

In an embodiment, the first subpanel includes a PV cell between a front sheet and a back sheet. The front sheet may be a thin glass or polymer layer. Such a construction may contrast with typical thick glass front sheets that are supported by frames. More particularly, the front sheet may be thin, polymeric, and/or frameless, and thus, the front sheet may be lightweight. Non-limiting examples of front sheet materials include ethylene tetrafluoroethylene (ETFE), Fluorinated ethylene propylene (FEP), Polyvinylidene difluoride (PVDF), Polyvinylidene fluoride (PVF), Polyethylene terephthalate (PET), glass and combinations or derivatives thereof. In an embodiment, the back sheet of the first subpanel may be a metal, polymer, glass, fiber reinforced polymer (e.g., fiber-glass reinforced polymer or polymer-reinforced polymer), a polymer matrix, or the like, or combinations thereof. Non-limiting examples of back sheet materials include glass, Polyethylene terephthalate (PET), Tedlar polyester (TPT), Thermoplastic elastomers (TPE), epoxy-, phenolic-, polypropylene-, vinylester-, or polyester-based fiber reinforced polymers (e.g. G10, G11, FR4, FR5), and combinations or derivatives thereof. The thickness of the back sheet can be in the range of 0.8 mm-2 mm for polymer laminates and 1 mm-3.2 mm for glass-based back sheets.

In one example, an intermediate UV (ultraviolet) light blocking layer can be included in the laminate, for example if the back sheet itself has limited UV stability. Non-limiting examples of a UV blocking layer include an opaque encapsulant (e.g. white or other colored polymer (e.g. oligomer or polymer of ethylene oxide like polyolefin elastomer (POE), ionomer, thermoplastic olefin (TPO). As another example, the back sheet can be painted with a UV blocking layer (e.g. solder mask, UV stable paint, etc.). As yet another example, a UV blocking front sheet and/or an opaque polymer interlayer (e.g. conventional PV back sheet materials) can be employed. The back sheet can be selected to have a minimum Relative Temperature Index (RTI) rating of 90° C., or more particularly from 105° C. to 130° C. to pass UL or other safety certification. More heat resistant materials that used in typical module back sheet may be employed. In some implementations, an outermost layer that has a high RTI rating even if it not a structural component may be used. For example, material such as Tedlar, Tedlar polyester (TPT), Ethylene tetrafluoroethylene (ETFE), Fluorinated ethylene propylene (FEP) could be employed rather than Polyethylene terephthalate (PET). This approach could be used at the seam or hinge assembly wherein the backmost material is an RTI rated but non-structural layer, but with the added constraint that it be flexible enough to allow for hinge or folding function.

In some implementations, core-shell constructions may be used. For example, a honeycomb or a foam filler can be employed as an interlayer within the back sheet to add stiffness with minimal weight. The filler can also be the same adhesive but with chopped fiber to reduce cost. As yet another example, a back sheet formed from of chopped fiber and adhesive such as epoxy or polypropylene (PP) can be employed, although chopped fibers at the surface of the laminate may have a detrimental effect on void creation during lamination. Non-limiting examples of fiber materials include glass, carbon, aramid, or basalt which can be woven, unidirectional, chopped or otherwise processed.

The PV cell may be any PV cell type. For example, the PV cell may be an interdigitated back contact cell, a front contact cell having overlapping cell sections, or a front contact cell. More particularly, the PV cell may be any known PV cell for converting insolation into electrical energy. In an embodiment, the first subpanel includes a first encapsulant layer (e.g., 100 μm-1000 μm thick) between the front sheet and the PV cell. The first encapsulant layer may be formed from an encapsulant material. For example, the encapsulant material may harden after curing to form a thin transparent film between the front sheet and the PV cell. Non-limiting examples of encapsulant materials include ethylene-vinyl acetate (EVA), thermoplastic olefin (TPO), polyolefin (PO), Thermoplastic polyurethane (TPU), Ionomers, and combinations or derivatives thereof. Similarly, the first subpanel may include a second encapsulant layer (e.g., 100 μm-1000 μm thick) between the PV cell and the back sheet. Accordingly, the PV cell may be encapsulated between the front sheet and the back sheet to form a frameless and lightweight first subpanel that can be mounted directly on a roof. The second subpanel may have a similar construction, e.g., including a respective PV cell between a respective front sheet and a respective back sheet. Thus, each subpanel of the folding PV panel may be a lightweight laminate, and the folding PV panel may be easy to handle and have a high wattage per pound ratio. By way of example, the folding PV panel may be configured to generate 100 W to 1 kW of electrical energy, and may have a total weight of 35 pounds or less.

In some implementations, the first and the second subpanel may have a different construction. For example, the materials and/or dimensions may differ by subpanel. A different set of encapsulants, front sheets and/or back sheets can be used for each subpanel, for example if a particular subpanel supports module-level power electronics (e.g. inverter) or if a subpanel provides additional mounting support. For example, the first panel can be stiffer or more rigid to resist mechanical loading compared to the second subpanel.

One or more electrical or electronic components may be integrated in the laminate structure of the first subpanel. For example, a diode may be mounted on or in the first subpanel. The diode may be disposed between the front sheet and the back sheet of the subpanel, e.g., within one of the encapsulant layers (e.g., an in-laminate diode). Accordingly, an in-laminate diode may provide diode protection for the folding PV panel. Alternatively, the diode may be mounted within the junction box to provide diode protection for the folding PV panel.

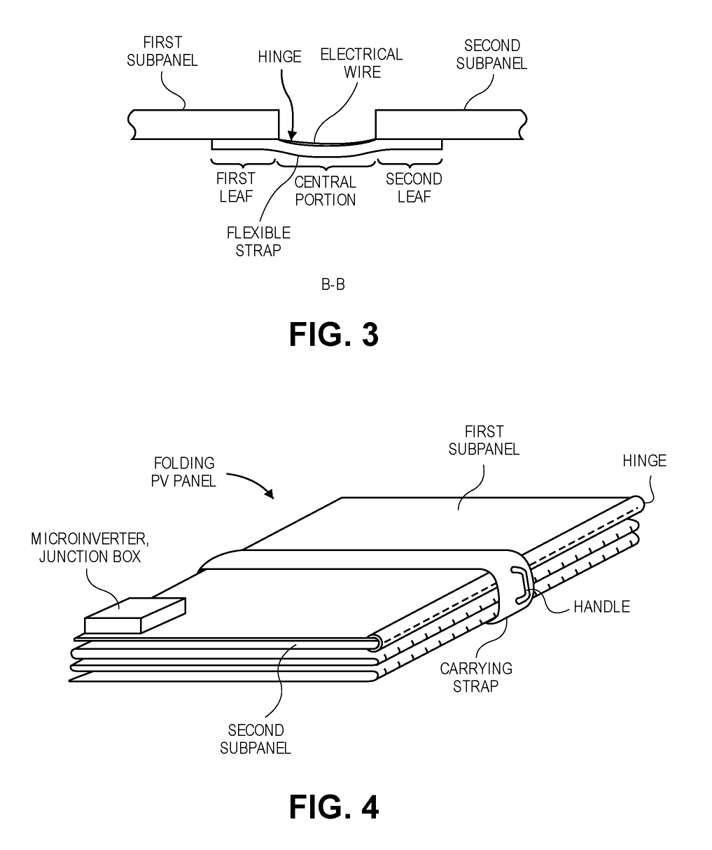

Referring to FIG. 3, a cross-sectional view, taken about line B-B of FIGS. 1A-C, of several subpanels of a folding PV panel interconnected by a hinge is shown in accordance with an embodiment of the present disclosure. The hinge may interconnect the first subpanel and the second subpanel. For example, the hinge may have a first leaf connected to the first subpanel, and a second leaf connected to the second subpanel. The first leaf and the second leaf may move relative to each other via a flexible or rotatable coupler. By way of example, the hinge may include a flexible strap, and the first leaf and the second leaf may be sections of the flexible strap. The flexible strap can be fabricated from a strip or film of flexible material, e.g., a fiber reinforced rubber, a composite film, etc. The hinge can also be formed as part of a laminate during a lamination process or added afterwards. The hinge can have insulators for the electrical components. The insulators can be laminated or mounted after the lamination process is complete.

The flexible strap can include a central portion integral to the first leaf and the second leaf. The first leaf, the second leaf, and the central portion may be sections of the flexible strap defined by their placement relative to the subpanels of the folding PV panel. The first leaf may be the section of the flexible strap mounted on the first subpanel, the second leaf may be the section of the flexible strap mounted on the second subpanel, and the central portion may be the section of the flexible strap that bridges a gap between the first subpanel and the second subpanel. Each leaf of the hinge can be attached to a respective subpanel using a mechanical, adhesive, or thermal bond. For example, the leaves may be fastened to the subpanels by screws, the leaves may be glued to the subpanels, or the leaves may be welded to the subpanels.

Electrical or electronic components may be mounted on the hinge. For example, an electrical conductor (e.g., a wire, a ribbon, or the like, or combinations thereof), may traverse a length and/or width of the hinge. The electrical conductor may be attached to the hinge, e.g., by being laminated onto the hinge seam. The electrical conductor may provide a conductive return to transfer electrical power from the PV cell to the microinverter or the junction box. Other electrical or electronic components, such as the diode described above or conductive ribbons, may be mounted on the hinge, e.g., within the gap between the first subpanel and the second subpanel. The hinge may also have an encapsulant or another insulation to isolate and protect the ribbon from the environment. The electrical conductor and/or electronic components can run along or across the seam. For example, the electrical conductor may run in any direction (longitudinally through the gap, transversely across the gap, slanted across the gap, vertically through the hinge, etc.) across the hinge to electrically interconnect a PV cell of the first subpanel with a PV cell of the second subpanel. The electronic components can be disposed within the seam or outside of the seam to interconnect the respective panels.

Referring to FIG. 4, a perspective view of a folding PV panel in a folded configuration is shown in accordance with an embodiment of the present disclosure. The hinges of the folding PV panel can be bent into a closed configuration to stack the subpanels for shipment. For example, the first subpanel may be stacked on the second subpanel such that the back sheet of the first subpanel faces the back sheet of the second subpanel. In an embodiment, the front sheet of the first subpanel supporting the microinverter or the junction box may face outward from the stack of subpanels.

In the stacked configuration, the folding PV panel may have a compact form factor. In an embodiment, the folded PV panel occupies an envelope having a length of 48 inches or less, a width of 40 inches or less, and a thickness of 3 inches or less. A total weight of the folded PV panel may be less than 50 pounds, e.g., 20 pounds. Thus, the folded PV panel may be easily carried.

To facilitate handling, a carrying strap may be wrapped around the folded PV panel and secured to retain the folding PV panel in the stacked configuration during shipment and handling. A handle may be attached to the carrying strap to allow an installer to easily pick up the folding PV panel as a bundle. As described above, the bundle of stacked subpanels can have a 1 kW power generation capacity. In an embodiment, more than one folding PV panel can be strapped together to be carried as a single unit. For example, several folding PV panels may be bundled together by a securing strap, and the bundle of panels can be carried on a back of an installer, e.g., as a backpack.

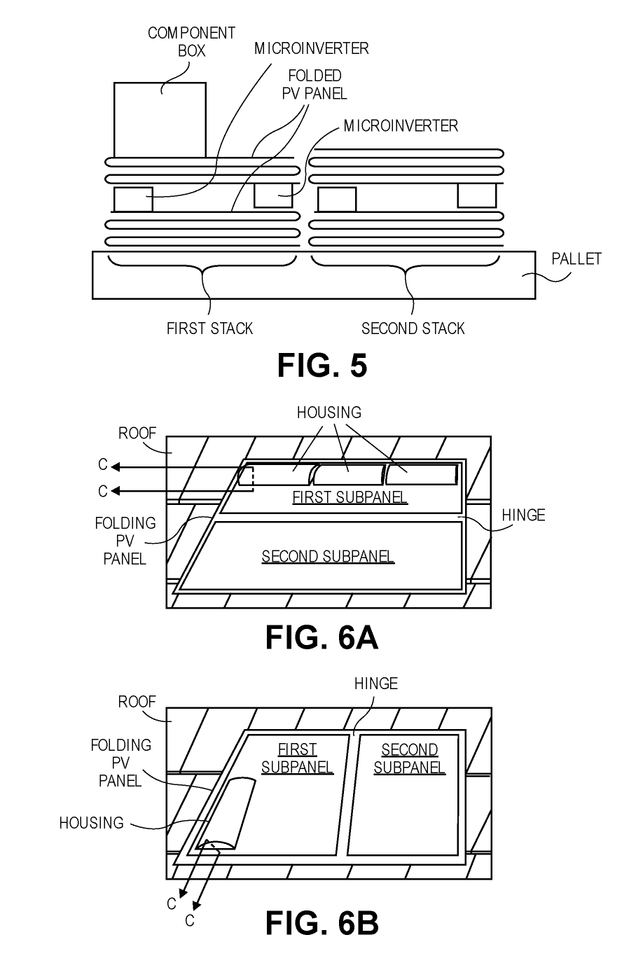

Referring to FIG. 5, a side view of a several folding PV panels in a folded configuration on a shipping pallet is shown in accordance with an embodiment of the present disclosure. Several folded PV panels may be shipped on a single shipping pallet. By way of example, a package of PV panels may include four folded PV panels stacked and nested on a pallet. The package can include a first stack of two folded PV panels stacked on the pallet next to a second stack of two folded PV panels. Each stack of PV panels can include one or more integrated power converters (e.g., dc-dc converters, microinverters, or the like, or combinations thereof) between the subpanels of the stacked folded panels. For example, a microinverter mounted on the first subpanel of a bottom folded PV panel may support the first subpanel of a top folded PV panel, and a microinverter mounted on the first subpanel of the top folded PV panel may rest on the first subpanel of the bottom folded PV panel. In other words, the integrated microinverters can mechanically space and separate the stacked folded PV panels. Other components may be stacked on or between the folded PV panels. For example, the package may include a component box having the housings, flashing, cabling, etc., used to complete installation of the unfolded PV panels at the installation site.

In the illustrated configuration, the pallet can have a total power generation capacity of 4 kW and weigh 160 pounds, and thus, the package of folded PV panels provides an inexpensive and efficient shipping and handling solution. That is, the package provides an improved module logistics solution. The improved module logistics solution may also be efficiently implemented by distributors that do not ordinarily participate in the solar power market. For example, the folding PV panels may be sold and distributed by online retailers because the shipping and handling is simplified compared to existing PV module and racking system solutions.

Referring to FIG. 6A, a perspective view of a folding PV panel having a portrait orientation spread on a roof is shown in accordance with an embodiment of the present disclosure. At the installation site, the folding PV panel may be unfolded and mounted on a roof. The folding PV panel can be unfolded by spreading the hinges to open the angle between the subpanels, and to position the subpanels in a coplanar orientation. The coplanar first subpanel and second subpanel can be mounted directly on the roof. The unfolded PV panel can be mounted in any orientation. For example, the subpanels may be mounted in a portrait orientation in which a longest edge of the subpanels is directed sideways along the roof Alternatively, the subpanels may be mounted in a landscape orientation in which the longest edge of the subpanels is directed upward along the roof. FIG. 6B illustrates a perspective view of a folding PV panel having a landscape orientation spread on a roof in accordance with an embodiment of the present disclosure.

In an embodiment, two or more folding PV panels can be mounted together at the installation site. For example, a first folding PV panel can be spread and mounted on the roof adjacent to a second folding PV panel that is spread and mounted on the roof. The unfolded PV panels may have respective edges that are placed immediately adjacent to one another and parallel to each other. The parallel edges may run in any direction, and thus, the adjacent panels may be placed in series, i.e., in a lengthwise direction relative to a longest axis of the panels, or in parallel, i.e., in a transverse direction relative to the longest axis of the panels. The side-by-side panels may be interlocked to form a larger array. For example, a mechanical fastener, such as a pin or a clamp, may holds the adjacent edges of the panels together to form the panel array. The mechanical fastener can be an intermediate component, such as a cable that attaches to the panels at each end, a U-bolt that passes through receiving holes on each panel, etc. The folding PV panels can be electrically connected to each other, e.g., in parallel or in series. Accordingly, the several folding PV panels can be mounted in a larger PV array.

The folding PV panel may include other components mounted on the front or back of the subpanels. For example, one or more housings may be mounted on the front of the first subpanel, as illustrated, similar to FIG. 1C. In this example, plural discrete housings are shown (e.g., three discrete housings), but other examples may utilize any number of discrete housings or one single continuous housing (for instance the embodiment illustrated in FIG. 6B includes a single continuous housing). More particularly, the housing(s) may be mounted on the front side of the first subpanel. Furthermore, the housing(s) may be mounted over any another component, e.g., an electrical or electronic component, of the folding PV panel. For example, the housing(s) may be mounted over one or more of a power converter (e.g., dc-dc converter, microinverter, or the like, or combinations thereof) or a junction box (not shown). In a similar manner, accessory components, e.g., an electrical or electronic component, mounting components and/or housing(s) can be mounted on the back side of the folding PV panel.

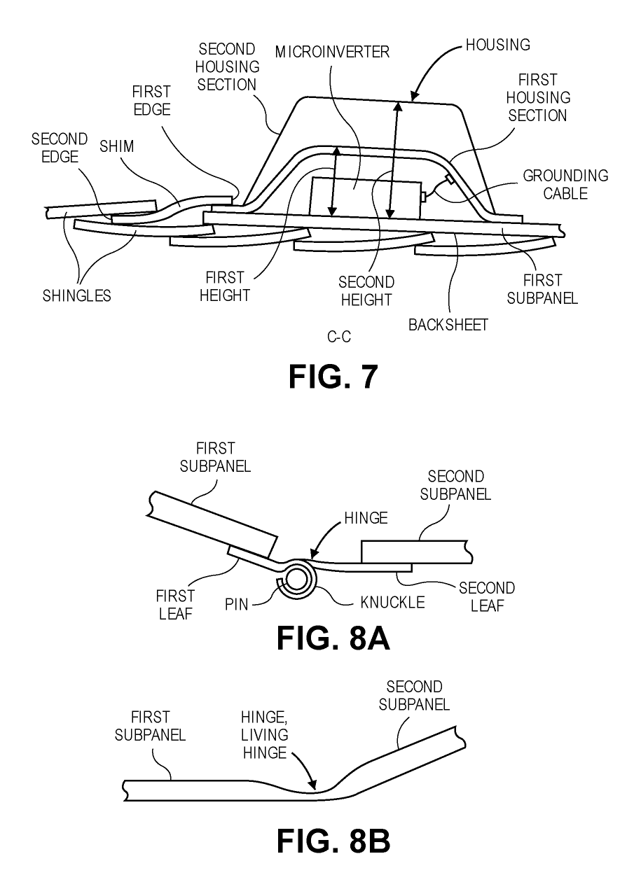

Referring to FIG. 7, a cross-sectional view, taken about line C-C of FIGS. 6A or 6B, of a folding PV panel mounted on a roof is shown in accordance with an embodiment of the present disclosure. Direct mounting of the folding PV panel on the roof may include resting the subpanels on shingles of the roof. In an embodiment, the back sheet of the first subpanel is placed directly on the shingles.

The first subpanel, and by extension the folding PV panel, may be attached to the roof by a flap or flashing that interacts with the shingles. In an embodiment, the folding PV panel includes a shim having a first edge and a second edge. The first edge may be connected to the first PV subpanel. For example, the first edge may be mechanically, adhesively, or thermally bonded to the first subpanel or the housing to secure the shim to the first subpanel. Similarly, the second edge of the shim may be attached to the roof. By way of example, the second edge may be mounted between a pair of shingles of the roof. The shim may be nailed into place, or otherwise fastened between the shingles. The pair of shingles can pinch the shim to provide a securing force that holds the first subpanel and the folding PV panel in place on the roof.

The first edge of the shim may be placed over the housing to direct water away from the electrical and electronic components mounted on the first subpanel. The microinverter and/or the junction box can be mounted on top of the first subpanel, and the housing may enclose the microinverter and/or the junction box to protect the components from rainwater rolling down the roof and the shim.

In an embodiment, the housing has different heights to prevent pooling of water above the module-level power electronics (e.g. microinverter, dc-dc converter, or the like, or combinations thereof). For example, the housing may include a first housing section having a first height above the first subpanel. The housing may include a second housing section having a second height above the first subpanel. The first height may be different than the second height. As shown, the first height may be less than the second height. Thus, rain falling on the second housing section may be shed onto the first housing section and may roll farther onto the first subpanel and the roof.

The microinverter and/or the junction box may be electrically connected to other components of the folding PV panel. For example, one or more of the microinverter or the junction box may be electrically connected to the electrical conductor routed along the hinge. That is, the electrical conductor may return electrical power from the PV cells to the microinverter or the junction box within the housing. A component of the folding PV panel, e.g., the housing, a back sheet of the subpanels, any other component of the folding PV panel, or combinations thereof, may be electrically grounded to the microinverter or the junction box. For example, the housing may be fabricated from metal, and thus, the housing may be grounded to the microinverter by a grounding cable. That is, the grounding cable may have a first end attached to the microinverter and a second end attached to the housing, e.g., by a screw. Similarly, the back sheet of the first subpanel may be fabricated from metal, and thus, the metal back sheet may be electrically grounded to the microinverter or the junction box by the grounding cable or a conductive coupling, such as a screw.

Referring to FIG. 8A, an alternative hinge interconnecting several subpanels of a folding PV panel is shown in accordance with an embodiment of the present disclosure. The hinge can include moving components. For example, the hinge may include a knuckle coupled to the first leaf. The hinge may also include a pin coupled to the second leaf. The pin may be located in the knuckle to allow relative movement between the first leaf and the second leaf. The mechanical hinge can therefore permit a change in the angle between the first subpanel and the second subpanel based on rotation of the knuckle about the pin.

Referring to FIG. 8B, an alternative hinge interconnecting several subpanels of a folding PV panel is shown in accordance with an embodiment of the present disclosure. The hinge may be integrated with the subpanels of the folding PV panel. For example, the hinge may be a living hinge between the first subpanel and the second subpanel. The living hinge may be a necked region over which a distance between the front sheet and the back sheet of the subpanels decreases. More particularly, the living hinge may be thinner and more flexible than other regions of the subpanels that include the PV cells. Accordingly, the first subpanel may be a first region of a monolithic panel, and the second subpanel may be a second region of the monolithic panel. The regions may be integrally formed and interconnected by the living hinge, which is a third region of the monolithic panel.

In addition to the advantages described above, the folding PV panel having several subpanels interconnected by a hinge can satisfy other key product requirements. For example, the folding PV panel may be fire compliant, may have a lifetime that supports a 10 year warranty, and may be easily and quickly mounted on the roof. These requirements may be met by the features described above, such as an all-polymer laminate subpanel construction.

It will be understood that the sequential arrangement of subpanels along a single longitudinal axis, as described above, is illustrative and other subpanel arrangements are possible. For example, the second subpanel may have a first hinge along a first edge and a second hinge along a second edge orthogonal to the first edge. The first hinge may interconnect the second subpanel with the first subpanel in a first direction, and the second hinge may interconnect the second subpanel with a third subpanel in a second direction orthogonal to the first direction. Accordingly, the first, second, and third subpanels may be arranged in an “L” pattern. The panels and hinges can be in one or two directions, and subpanels may be interconnected to any edge of an adjacent subpanel to form different arrangement patterns, such as a “Z” or an “0” pattern.

An electrical conductor (e.g., a wire, a ribbon, or the like, or combinations thereof) may extend from a first subpanel of any folding PV panel described herein to a second subpanel of the folding PV panel. In some embodiments, the first and second subpanels may be similar to any subpanels described herein (e.g., the first subpanel may include a first PV cell between a first front sheet and a first back sheet, and the second subpanel may include a second PV cell between a second front sheet and a second back sheet). The electrical conductor may electrically connect a component associated with the first subpanel (e.g., a PV cell of the first subpanel, a junction box mounted on the first subpanel, or the like, or combinations thereof) to a component associated with the second subpanel (e.g., a PV cell of the second subpanel, a junction box mounted on the second subpanel, or the like, or combinations thereof).

The folding PV panel may include a hinge assembly having a first section (e.g., a first leaf), a second section (e.g., a second leaf), and a third section (e.g., a central portion) between the first and second sections. The first section may be coupled to the first subpanel and the second section may be coupled to the second subpanel to allow an angle between a first lateral plane along which the first subpanel extends and a second lateral plane along which the second subpanel extends to change.

In some embodiments, the electrical conductor may be co-located with the hinge assembly (e.g., integrated into a seam of the hinge assembly). In other embodiments, the electrical conductor may not be co-located with the hinge assembly. In embodiment in which the electrical conductor and the hinge assembly are not co-located, the electrical conductor may be located in a channel defined by the third section of the hinge assembly and edges of the first and second subpanels. A cabling assembly may bridge the channel, and the electrical conductor may be located in the cabling assembly.

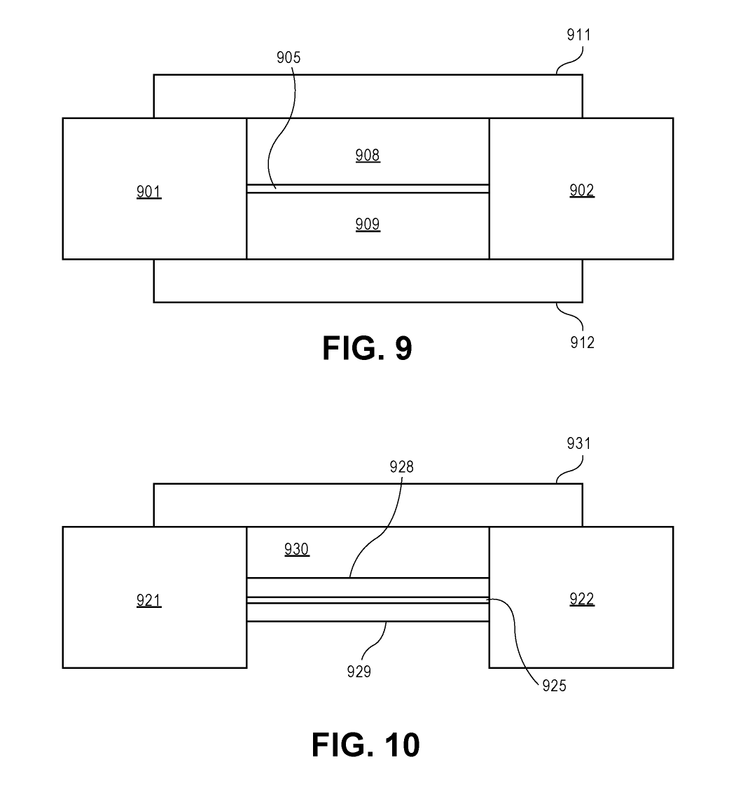

FIG. 9 illustrates a cross-sectional view of subpanels 901 and 902 of a folding PV panel interconnected by a hinge assembly, in accordance with an embodiment of the present disclosure. In the illustrated embodiment, the hinge assembly includes a first hinge 911 with a first section coupled to a first side of the subpanel 901 and a second section coupled to a first side of the subpanel 902. The hinge assembly includes a second hinge 912 with a first section coupled to a second side of the subpanel 901 and a second section coupled to a second side of the second subpanel 902.

The hinge assembly may also include an encapsulant layer between third sections of the hinges 911 and 912. An electrical conductor 905 may be embedded in the encapsulant layer. The encapsulant layer, shown in cross section, includes a first region 908 and a second region 909, nevertheless, the encapsulant layer may be a single layer in which the electrical conductor 905 is embedded. In some examples, the encapsulant layer may be formed from more than one layer (e.g., of the same material, formed at different times). In these embodiments, the electrical conductor 905 may be placed after forming one of the layers and before forming a different one of the layers.

Although the illustrated embodiment illustrates the electrical conductor 905 integrated into a hinge assembly including hinges on both sides of the subpanels 901 and 902, in other examples an electrical conductor may be integrated into a hinge assembly including hinge(s) on a single side of the subpanels 901 and 902. For instance, a single continuous hinge or discrete hinges having a first section coupled to first side of the subpanel 901 and a second section coupled to a first side of the subpanel 902, with no hinge coupled to the second sides of the first and second subpanels.

FIG. 10 illustrates a cross-sectional view of subpanels 921 and 922 of a folding PV panel interconnected by a hinge assembly that defines a channel with edges of the subpanels 921 and 922, in accordance with an embodiment of the present disclosure. In this illustration, the hinge assembly includes a hinge 931 including a first section coupled to a side of the subpanel 921 and a second section coupled to a side of the subpanel 922.

A third section of the hinge 931 and edges of the subpanels 921 and 922 defines a channel. A cabling assembly including an electrical conductor 925 bridges the channel. The electrical conductor 925 may be surrounded by an insulator, which in the cross-section illustration includes section 928 and 929.

In some examples, a gap 930 may be provided to mechanically separate the cabling assembly and the hinge assembly. Mechanical separation may reduce stress on the electrical conductor 925 assembly during folding and/or when the PV panel is folded up. In some examples, the electrical conductor 925 and/or the cabling assembly may be longer than a width of the channel to reduce stress imparted on the electrical conductor 925 and/or the cabling assembly during and/or when the PV panel is folded up.

In the illustrated embodiment, the cabling assembly is illustrated as bisecting the channel (e.g., dividing the channel into two equal parts). In other examples, the cabling assembly may be offset, e.g., closer to one of the first and second sides of the subpanels 921 and 922 than the other of the first and second sides of the subpanels 921 and 922.

In some examples, the cabling assembly may be located in a bottom of the channel, e.g., the section 928 may be proximate to the hinge 931 (e.g., in contact with the hinge 931, in some examples). In some examples, an adhesive may be deposited on the hinge assembly in the bottom of the channel and the cabling assembly may be mounted on the adhesive.

The electrical conductor 925 may extend into the subpanels 921 and 922 (not shown). In some examples, the electrical conductor 925 may be self-sealed and the seal may also extend into the subpanels 921 and 922 (such a seal may be deposited on the electrical conductor 925 by any method such as by dipping the electrical conductor 925 into a liquid). In some examples, a layer of insulation may be formed around the electrical conductor 925 (and a seal if present) for only the portion of the electrical conductor 925 exposed in the channel (e.g., this layer of insulation may not extend into the subpanels 921 and 922). Such layers of insulation may be formed on the exposed electrical conductor (and seal if present) after the electrical conductor is positioned within the channel.

Although the illustrated embodiment of FIG. 10 includes a hinge 931 coupled to first sides of the subpanels 921 and 922 with no hinge coupled to the second sides of the subpanels 921 and 922, other embodiments with a cabling assembly that is not co-located with the hinge assembly may include a hinge (not shown) coupled to second sides of the subpanels 921 and 922 that are opposite the first sides. In these examples, the channel is defined by the edges of the subpanels 921 and 922 and the central section of each of the hinges. Also, the cabling assembly may be mechanically separated from one or both hinges.

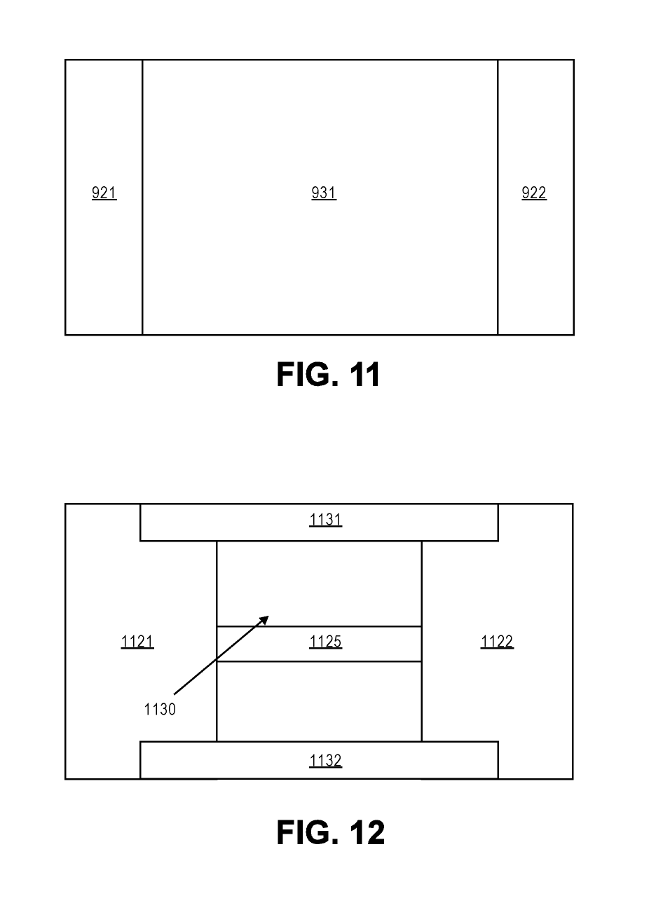

FIG. 11 illustrates a top view of the folding PV panel of FIG. 10. In this example, the hinge may include a single continuous foldable seam, which may include one or more flexible layers (such as laminated layers of flexible material).

FIG. 12 illustrates a top view of a folding PV panel interconnected by a hinge assembly with a plurality of discrete hinges coupled to a same side of the subpanels 1121 and 1122, in accordance with an embodiment of the present disclosure. The folding PV panel is similar to the folding PV panel of FIGS. 9-10 with a channel defined by edges of the subpanels 1121 and 1122 and a central section of the hinge assembly. However, in this example the hinge assembly includes a plurality of discrete hinges 1131 and 1132 coupled to a same side of the subpanels 1121 and 1122. Each of the discrete hinges 1131 and 1132 may be a seam or rigid componentry such as a first component rotatably coupled to a second component (these components in some embodiments may include the earlier described knuckle and pin). A space between the hinges 1131 and 1132 defines an opening 1130 exposing the cabling assembly 1125 in the channel. The opening 1130 may provide access to the cabling assembly 1125, for instance when the folding PV panel is unfolded.

The illustrated embodiment of FIG. 12 depicts hinges 1131 and 1132 coupled to first (top) sides of the subpanels 1121 and 1122, however it should be appreciated that hinges can also be coupled to second (bottom) sides of the subpanels 1121 and 1122 and in other embodiment hinges can be absent from the second sides of the subpanels 1121 and 1122. Furthermore, hinges can be alternated such that a first discrete hinge is coupled to a first side of the subpanels and a second discrete hinge can be coupled to the second side of the subpanels.

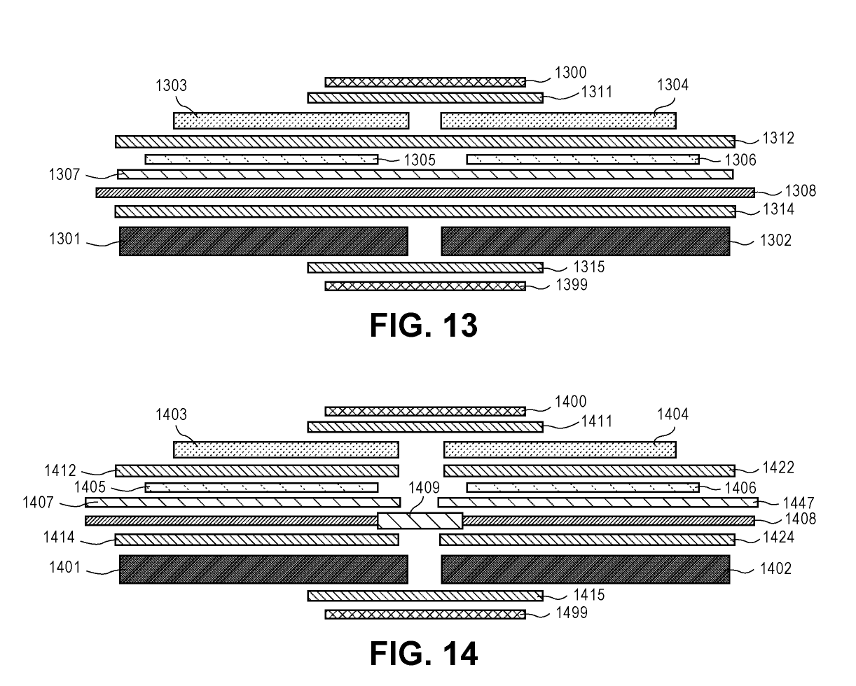

FIG. 13 illustrates a cross-section view of a ribbon joint of a folding PV panel with a ribbon 1308 embedded in encapsulant material of a seam of a hinge assembly. The ribbon joint includes a first subpanel including a back sheet 1301, cells 1305, and a front sheet 1303, and a second subpanel including a back sheet 1302, cells 1306, and a front sheet 1304. The hinge assembly of this ribbon joint may have a seam including the ribbon 1308, the encapsulant layers 1312 and 1314, barrier strips 1300 and 1399, seam layers 1311 and 1315 (which may be formed from a same material or a different material than a material of the encapsulant layers 1312 and 1314).

The ribbon 1308 may be similar to any previously described electrical conductor, extends from the first subpanel to the second subpanel. In this example, the ribbon 1308 is embedded in an encapsulant, e.g., located on the encapsulant layer 1314 and may also be covered by encapsulant layer 1312. In some implementations a plurality of encapsulant layers can be provided at 1312. An electrical barrier 1307, which may include a layer such as an EPE (expanded polyethylene) layer in some embodiments, may insulate the cells 1305 and 1306 (e.g., may be located between the ribbon 1308 and the cells 1305 and 1306).

Encapsulant or laminating adhesive layers can be provided in any desirable thickness. In some implementations, a plurality of layers of similar material can be used to increase thickness. For example, a single encapsulant or laminating adhesive layer can be provided towards the front (e.g. at 1312) in the range of 200-600 microns or in other implementations, two encapsulant layers can be provided to result in a thickness of 400-1200 microns. As another example, a single encapsulant or laminating adhesive layer can be provided towards the back (e.g. at 1314) in the range of 200-600 microns.

FIG. 14 illustrates a cross-section view of a ribbon joint of a folding PV panel with an isolated ribbon 1408. The ribbon joint includes a first subpanel including a back sheet 1401, cells 1405, and a front sheet 1403, and a second subpanel including a back sheet 1402, cells 1406, and a front sheet 1404. A hinge assembly of this ribbon joint may include barrier strips 1400 and 1499, and seam layers 1411 and 1415. Electrical barrier 1407 and 1477, which may be similar to electrical barrier 1307 (FIG. 13), may insulate, respectively, the cells 1405 and 1406 (e.g., may be located between the ribbon 1408 and the cells 1405 and 1406, respectively)

Encapsulant layers 1412, 1414, 1422, and 1424, and the ribbon 1408 are isolated from the hinge assembly, which may reduce stress on the ribbon 1408. The ribbon 1408 may be located in a channel formed by the edges of the first and second subpanels and the edges of the encapsulant layers 1412, 1414, 1422, and 1424. A seal 1409 may be formed around a portion of the ribbon 1408 in the channel (in other examples, at least one layer of the seal may be formed around other portions of the ribbon 1408 as well).

By not requiring encapsulant and/or cover material to isolate the portion of an electrical connector (e.g., the ribbon 1408) between the first and second subpanels, a total thickness of a laminate stack of the ribbon joint of FIG. 14 may be reduced as compared to embodiments in which a portion of an electrical connector between first and second subpanels embedded in such materials. This reduced thickness may increase flexibility of the hinge. Mechanically separating the electrical connector from the hinge (such as shown in FIG. 14) may reduce stress on the electrical connector.

In some examples, the barrier strips 1400 and 1499 may be different materials and/or different dimensions. In some examples, the barrier strip 1499 may be omitted and/or replaced with foam or other material to make contact with a roof. The barrier strip 1400 may provide adequate flashing. In examples where the hinge assembly forms an opening exposing the channel, the barrier strip 1400 may form a flashing function to cover the opening and may be removed if accessing to the opening becomes necessary.

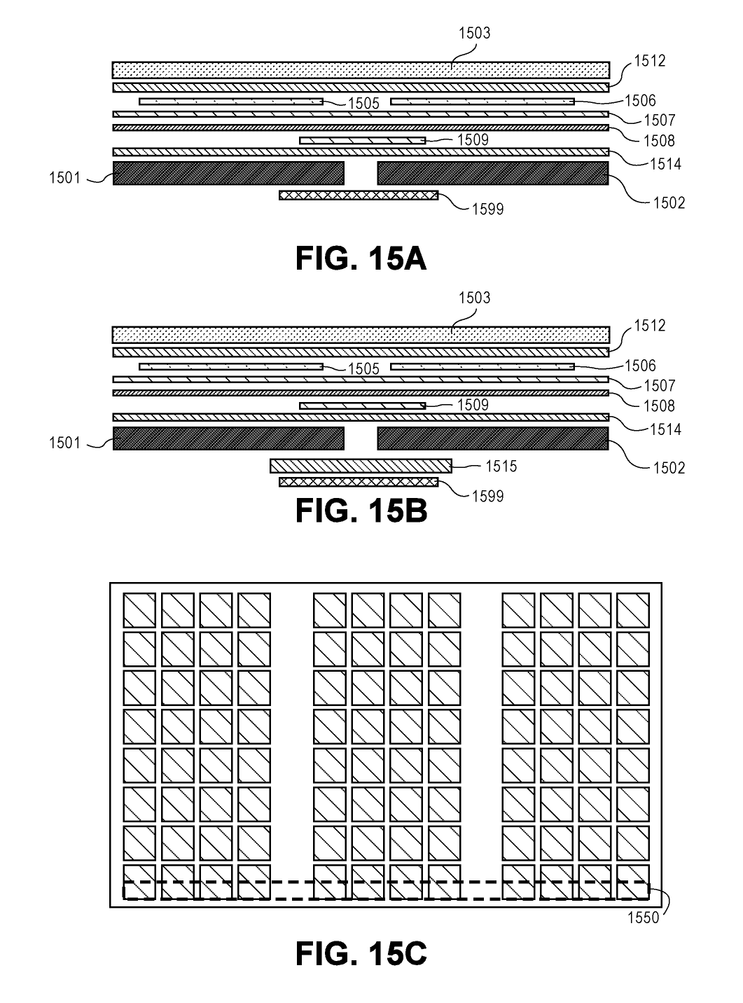

FIG. 15A illustrates a cross-section view of another embodiment of a ribbon joint of a folding PV panel with a ribbon 1508 embedded in an encapsulant material of a seam of a hinge assembly. The ribbon joint includes a first subpanel including a back sheet 1501, and cells 1505, and a second subpanel including a back sheet 1502, and cells 1506. A barrier strip 1599 may be in physical contact with back sheets 1501 and 1502, e.g., may be directly adhered to back sheets 1501 and 1502. In another example depicted in FIG. 15B, an encapsulant layer 1515 can be included between back sheet 1502 and barrier strip 1599.

In this embodiment, a front sheet 1503 is continuous over the seam between the first and second subpanels. This is in contrast to the stack including the non-continuous front sheets, made of similar materials, 1303 and 1304, barrier strip 1300, and seam layer 1311 of the embodiment illustrated in FIG. 13. Referring again to FIG. 15A, the hinge assembly of this ribbon joint may have a seam including the ribbon 1508, the encapsulant layers 1512 and 1514, and the barrier strip 1599. The ribbon 1508, which may be similar to any previously described electrical conductors, extends from the first subpanel to the second subpanel. In this example, the ribbon 1508 is embedded in an encapsulant, e.g., located on the encapsulant layer 1514 and may also be covered by encapsulant layer 1512.

An electrical barrier 1507, which may include an EPE layer in some embodiments, may insulate the cells 1505 and 1506 (e.g., may be located between the ribbon 1508 and the cells 1505 and 1506). A mechanical guide 1509 may be located on the other side of the ribbon 1508. The mechanical guide 1509 may provide stiffness to the side of the ribbon 1508 that corresponds to the stiffness provided by the electrical barrier 1507 on the other side of the ribbon 1508. In some embodiments, the mechanical guide 1509 is formed from the same material as the electrical barrier 1507.

FIG. 15C illustrates a top view of a folding photovoltaic (PV) panel employing the ribbon joint of FIG. 15A. A dashed line 1550 indicates the location of the electrical barrier 1507 and the mechanical guide 1509. As indicated by the dashed line 1550, the electrical barrier 1507 and the mechanical guide 1509 may be oriented cross wise (e.g., orthogonal) with seams of the folding PV panel.

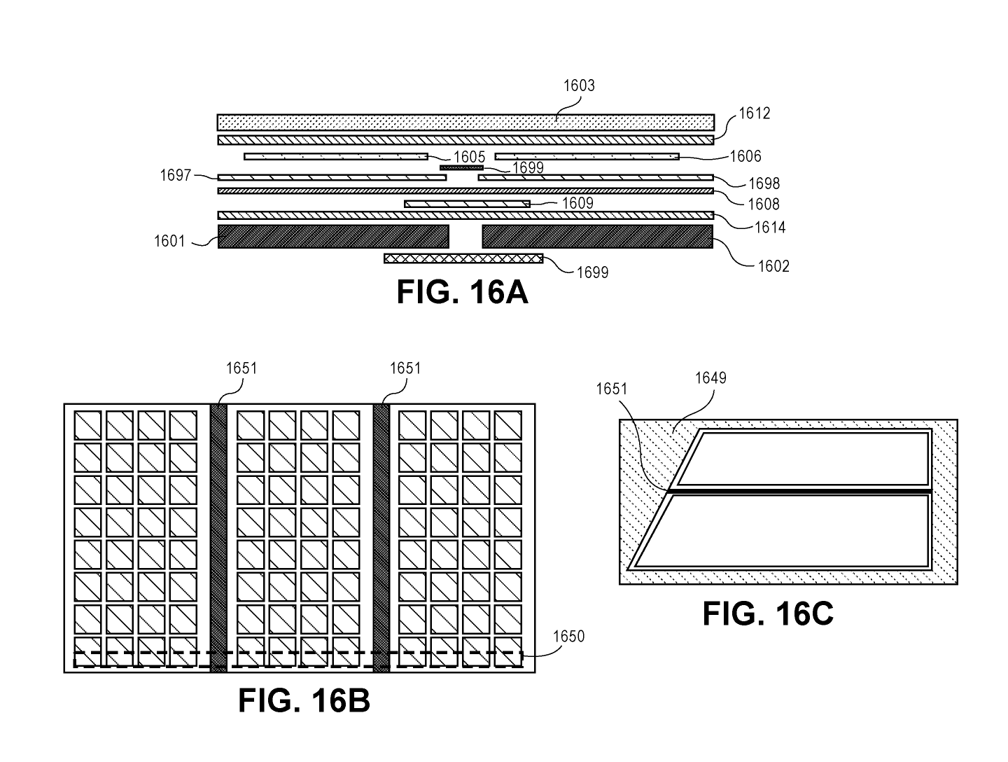

FIG. 16A illustrates a cross-section view of yet another embodiment of a ribbon joint of a folding PV panel with a ribbon 1608 embedded in an encapsulant material of a seam of a hinge assembly. The ribbon joint includes a first subpanel including back sheet 1601, and cells 1605, and a second subpanel including a back sheet 1602, and cells 1606, and a continuous front sheet 1603.

The hinge assembly of this ribbon joint may have a seam including the ribbon 1608, the encapsulant layers 1612 and 1614, and a barrier strip 1699. The ribbon 1608, which may be similar to any previously described electrical conductor, extends from the first subpanel to the second subpanel. In this example, the ribbon 1608 is embedded in an encapsulant, e.g., located on the encapsulant layer 1614 and may also be covered by encapsulant layer 1612.

The electrical barriers 1697 and 1698, which may each include an EPE layer in some embodiments, may insulate the cells 1605 and 1606, respectively (e.g., may be located between the ribbon 1608 and the cells 1605 and 1606, respectively). A mechanical guide 1609 may be located on the other side of the ribbon 1608. The mechanical guide 1609 may provide stiffness on to the side of the ribbon 1608 that corresponds to the stiffness provided on the other side of the ribbon 1608.

A seam cover 1699 may be located proximate to a gap between the electrical barriers 1697 and 1698. The seam cover 1699 may be formed using similar material as the mechanical guide 1609 and/or the electrical barriers 1697 and 1698. However, the material of the seam cover 1699 may be of a different color than the material of the mechanical guide 1609 and/or the electrical barriers 1697 and 1698 (e.g., a black EPE layer). In some examples, the seam cover 1699 may include additional/different particles and/or an additional/different layer than the mechanical guide 1609 and/or the electrical barriers 1697 and 1698, which may make the seam cover 1699 black (or some other selected color).

In some embodiments, first color layers (e.g., including a white EPE material) of an electrical barrier is one either side of a seam, and a second color layer (e.g., including a black EPE material) of a seam cover is in the seam. The second color layer may overlap a portion of the first color EPE layers (to avoid any gap exposing a layer below the first color layers, e.g., to avoid exposing the ribbon 1608). FIGS. 16B-C illustrate, respectively, a top view of a folding photovoltaic (PV) panel employing the ribbon joint of FIG. 16A and a perspective view of the folding PV panel spread on a roof 1649. As illustrated by the dashed line 1650 of the top view of a folding PV panel including this ribbon joint, the first color layers may run length wise to modules of the folding PV panel (e.g., between ribbon 1608 and cells 1605 and 1606). Color stripes 1651 (created by the second color layers) may run cross wise to the modules (color stripes 1651 are also shown running cross wise to the modules in an isometric view of a portion of a similar folding PV panel mounted on a roof 1649).

In any embodiment described herein, the electrical conductor and/or the cabling assembly may include one or more strain relief features to reduce stress on the electrical conductor and/or the cabling assembly, such as an intentional kink, a jog (e.g., providing sufficient length so that in an unfolded position a segment of the electrical conductor or cabling assembly is in a substantially orthogonal to a rest of the electrical conductor or cabling assembly), a diagonal, or the like, or combinations thereof. A diagonal or a jog may be in a lateral plane parallel to lateral planes of the first and second subpanels (in an unfolded position), or in a plane that is intersecting with the lateral planes of the first and second subpanels (in an unfolded position). An electrical conductor and/or a cabling assembly may be pre-kinked prior to folding. A kink formed by pre-kinking (e.g., an intentional kink) may prevent an unintentional formation of a kink during folding. The kink may be formed by impact the electrical conductor or cabling assembly with an object, say a non-rounded or rounded edge/corner of an object.

In examples in which the hinge assembly is mechanically separated from an electrical conductor using a separate cabling assembly, a hinge may be coupled to a first side of the subpanels of a folding PV panel via a discontinuous adhesive layer formed only on the subpanels. In examples in which the hinge assembly is not mechanically separated from the electrical conductor, this adhesive layer may be a single continuous adhesive layer formed on the subpanels and a structure between the subpanels, such as on an encapsulant layer located between the subpanels (an electrical conductor may be embedded in such encapsulant between the subpanels). In other examples, a mechanical fastener may be used instead and/or in addition to the adhesive to secure a hinge to the subpanels and/or to components formed between the edges of the subpanels.

In any embodiments described herein, a location of the electrical connector relative to a neutral axis (a location of equal stiffness on top and bottom) may be selected to bias a tension or compression on different portions of the electrical connector differently. Placing the electrical connector along the neutral axis will generally minimize stress. However, if an electrical connector has characteristics more suited to compression than tension, it may be advantageous to place such an electrical connector off of the neutral axis, closer to a front panel. Conversely, if an electrical connector has characteristics more suited to tension than compression, it may be advantageous to place such an electrical connector off of the neutral axis, closer to a back panel.

In any of the embodiments described herein an electrical conductor may include more than one layer of insulation. The electrical conductor may include a seal and an additional layer in which the electrical conductor is to be embedded. The additional layer may be formed by placing the electrical conductor in a heat encapsulant that is malleable. The seal may provide protection if the electrical conductor moves relative to the encapsulant (e.g., kinks) before the malleable material cools completely (protecting against a thinner region of the encapsulant related to the movement relative to the encapsulant).

In some embodiments, an electrical component (such as the micro inverter and/or the junction box) may be mounted on top of any subpanel, such as the first subpanel as described with respect to the embodiment illustrated in FIG. 7. In other embodiments, the electrical component may be mounted under any subpanel. For instance, a folding PV panel may include three subpanels, e.g., a first subpanel to mount furthest from an edge of the roof, a second subpanel, and a third subpanel to mount closest to the edge of the roof. The electrical component may be mounted under any of the subpanels, such as the first subpanel or the third subpanel.

The electrical component may be mounted near an edge of one of the subpanels. In the case of mounting under the third subpanel, the edge may be an edge (of the third subpanel) to be closest to the edge of the roof. In this case, when installed, the bottom of the third subpanel may be sloped less than a slope of the bottom of the other subpanels. Alternatively, in the case of mounting under the first subpanel, the edge may be one of the edges (of the first subpanel) to be closest to the edge of the roof. In this case, the bottom of the first subpanel may be sloped less than a slope of the bottom of the other subpanels.

In the embodiment in which the electrical component is mounted under the first subpanel near the edge (of the first subpanel) that is closest to the edge of the roof, a seam between the first and second subpanel may be a different length (e.g., longer) than a seam between the other subpanels (e.g., between the second and third subpanels, in this case). However, in the embodiment in which the electrical component is mounted under the third subpanel near the edge (of the third subpanel) that is closest to the edge of the roof, a seam between the second and third subpanel, the seam may not necessarily be a different length than a seam between the other subpanels (e.g., between the first and second subpanels, in this case), or may be a different length but not as long as a seam in the first subpanel under-mounting embodiment. Stress on the seam between the second and third subpanels (in the third-subpanel under-mounting embodiment) may be less than a stress on the seam between the first and second subpanels (in the first-subpanel under-mounting embodiment). Due to the reduced stress, it may be easier to lay this seam flat during installation, and this seam may be constructed similarly (in design, dimensions, materials, or the like, or combinations thereof) as other seams in the folding PV panel.

Different under-mounting configurations may offer advantages that are application dependent, e.g., that depend on characteristics of the roof. In third-subpanel under-mounting embodiments, the electrical component may be close to the roof edge, which may make it easier to string the folding PV panel in the field for some roofs (due to better access to the electrical component from the roof edge in applications in which roof edge access is better than other access). However, in first-subpanel under-mounting embodiments, a load on the third section may be lower, which may require fewer roof penetrations and/or fasteners, which may be an advantage for some roofs.

In any mounting configuration, one seam of the folding PV panel may be a different width than another seam of the folding PV panel to accommodate folding for the electrical component. For instance, in a folding PV panel with an electrical component mounted to a one of the subpanels, a seam between that subpanel and another subpanel may be wider than a seam between the other subpanels. For instance, the wider seam may be 45 mm wide and the other seam may be 25 mm wide.

In any of the embodiments described herein, one or more holes may be formed in the seam, e.g., in one or more layers of the seam. For example, referring to

FIG. 13, the holes may be formed in some or all of the ribbon 1308, the encapsulant layers 1312 and 1314, barrier strips 1300 and 1399, seam layers 1311 and 1315 (which may be formed from a same material or a different material than a material of the encapsulant layers 1312 and 1314). In some examples, the holes may be formed by punching into the seam. The one or more holes may be for a fastener (e.g., a fastener to secure the folding PV panel to a roof), an electrical connector (e.g., an electrical connector from a component mounted on top of a folding PV panel to an electrical connector below the folding PV panel), for venting, or the like, or combinations thereof. The one or more holes may have the same or different shapes, e.g., circular holes, oval shaped holes, or slots such as in louvres.

### Self-Shingling

PV modules may be arranged on rigid frames and secured to a support structure in order to support the PV modules and align them to a desired direction and angle. The rigid frames may be mounted to a roof of a building and may be mounted to a standalone structure for supporting the PV modules. Assembly of these systems can be time consuming as the frame constructions would first need to be completed and then each PV module is, one at a time, connected to the frame.

Arrays of PV cells may be configured to be connected in a folding fashion. These PV cells may be organized on panels where several panels may form a PV module. In embodiments a series of two or more panels of PV cell arrays may be connected to each other such that the first panel may be folded over the second panel for shipping or storage purposes. At the time of installation, the panels may be unfolded and installed in a sequential fashion, with one panel of PV cells connected to the second panel of PV cells of the PV module. The panels of PV cells may be connected such that they lie on the same plane when in an extended position. The panels of PV cells may also be connected such that they overlap when in an extended position.

This section describes various processes, systems, devices, and articles of manufacture whereby any folding PV panel described herein or components thereof may employ self-shingling techniques or designs. These self-shingling techniques or designs may allow PV modules to be unfolded or otherwise readily adjoined to each other during installation. These techniques and designs may include packaging, unpackaging, assembling, connecting, installing, and maintaining PV modules. These modules may comprise a single array of PV cells as well as a plurality of PV cell arrays. The modules may also comprise an inverter connected to one or more array of PV cells comprising the PV module. Other components may or may not also be present in self-shingling PV modules of embodiments.

Embodiments may provide processes, systems, devices, and articles of manufacture whereby PV modules, which can comprise one or more one-dimensional or two-dimensional arrays of PV cells, may be configured to be connected in a folding fashion. The PV modules may also be configured such that previously unconnected PV modules may be readily attached to one another. In embodiments a series of two or more panels of PV cell arrays may be connected to each other such that the first panel may be folded over the second panel for shipping or storage purposes. At the time of installation, the panels be unfolded and installed in a sequential fashion, with one panel of PV cells connected to the second panel of PV cells of the PV module. The panels of PV cells may be connected such that they lie on the same plane when in an extended position. The panels of PV cells may also be connected such that they overlap when in an extended position. This overlap may be consistent along an entire edge and may be inconsistent as well. In preferred embodiments the overlap may be consistent and may be limited to the edge area of the adjoining PV panel such that underlying PV cells are not shaded by the overlying PV panel. The PV modules may include microinverters and/or other electronics. The PV modules may also include connectors and/or cables in order to connect two or more PV panels or PV modules together. The seams that connect the PV modules may be continuous along a side or edge of a PV module and may lie along only portions of an edge of side of a PV module as well. The electrical conductors between PV modules may be embedded in the seam or seams and may lay outside of the seams as well in embodiments.

One or more borders of PV panels comprising a PV module may include a flexible folding seam. This folding seam may be secured on two faces of each adjoining PV panel as well as fewer than two faces of each adjoining PV panel. The seam may be secured so as to allow two adjacent PV panels to be folded back on each other. The seam may also be configured and secured such that when adjoining PV panels are unfolded they panels rest on the same plane or one PV panel overlaps another PV panel. A PV module may also include more than two PV panels secured as described herein. For example, a PV module may include five PV panels secured to each other in a row whereby they may be folded back onto each other into a stack at manufacture and then unfolded into a single line of five PV panels. The seams connecting the five panels may be the same or may be different. For example, panels 1-2-3 may lie on the same plane while panels 4-5 may overlap each other. In embodiments, PV panels may also be connected such that they form Tetris like shapes. In other words, rather than having all of the panels lie along the same line, some PV panels may be connected to one side and form an “L” or “T” or “S” shape. Other non-linear shapes may also be formed.

In embodiments, the seals may be secured to two surfaces of the PV panels as well as only one. The seal may be mechanically secured to top, bottom, as well as edge surfaces of the PV panels. The securement may be through mechanical techniques, such as tongue and groove or other male/female securement designs. The securement may also be through adhesives and through combinations of mechanical techniques and adhesives.

The electrical components of a PV module may be secured to one PV panel as well as different PV panels of the PV module. For example, in a linear string of four PV panels making up a PV module, two panels may have connectors to connect adjoining PV modules, a third PV panel may have no connectors, and the fourth PV panel may have a microinverter and one connector to couple the microinverter to another PV module or some other type of daisy chain connector.

In embodiments, the PV panels of a PV module may be internally electrically connected to each other. These connections may pass through the seams connecting adjoining panels. These connections may also pass above, below, or otherwise around the seams connecting the PV panels. In some embodiments exposed connections between PV panels may need to be completed in the field while in some embodiments exposed connections may be completed upon manufacture or assembly prior to shipping.

In embodiments, the seam may be secured to adjoining PV panels of the same PV module such that the PV panels may be positioned above or below adjoining PV panels. There may be a single seam along a majority of an edge of face of a PV module as well as a plurality of seams serving to connect two or more PV modules together.

In embodiments, PV panels and PV modules may also be configured to mate with adjacent PV panels and adjacent PV modules not previously attached to them. This mating of adjacent PV modules (and their constituent PV panels) may include overlap joinery or channel joinery or both. Channel joinery may include congruent connectors to allow adjacent PV panels of different PV modules to connect with each other. The congruent connectors may be configured such that a wire channel or trough is created within, below, or above the connectors. Other configurations of connectors may also be employed.

Embodiments may also provide for offset spacing between adjacent PV modules. In other words, adjacent PV modules of the same size and shape may not align up evenly but may be staggered from PV module to PV module. This staggering can occur both along top edges of the PV modules and side edges of PV modules. The shape of the congruent connectors may provide for this staggering and may provide an alignment feature as well. This alignment feature may set a staggering distance or position or both with respect to adjacent PV modules.

Still further configurations are possible, using individual features of the various embodiments described herein to form still further embodiments.

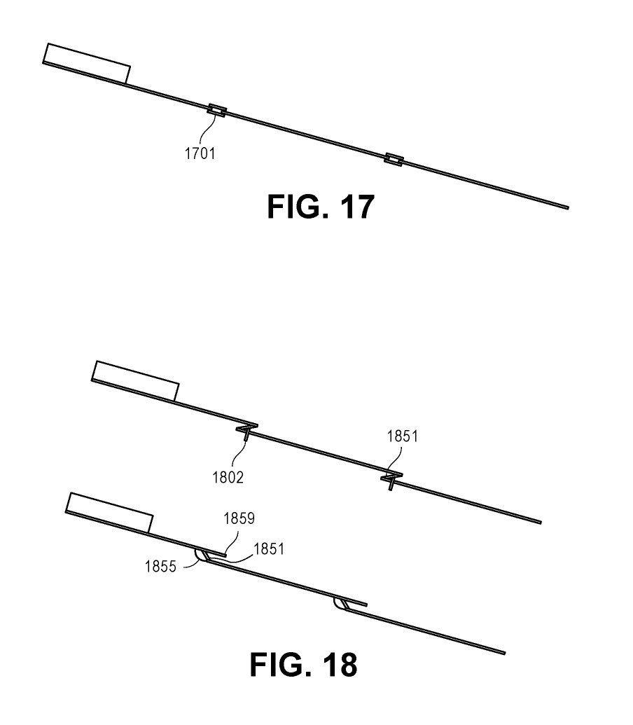

Referring now to FIG. 17, a PV module comprising three PV panels with upper mounted electronics (e.g. microinverter or junction box) is shown. As can be seen, there are upper and lower seams 1701 connecting the first PV panel to the second PV panel and the second PV panel to the third PV panel. As can also be seen, the PV panels are laying in the same plane. The dual seams 1701 between each PV panel allows the PV panels to be folded over one another, which may be useful during shipping, storage, onsite-handling, etc.

Referring to FIG. 18, two PV modules, each comprising three PV panels, are shown. The top PV module shows PV panels connected with a “z” seam 1801 while the lower PV module shows PV panels connected with recessed “k” seams 1851. A “z” seam 1801 can be formed such that a seam section spans or connects a boundary edge of a first PV panel and a boundary edge of a second PV panel. A “k” seam 1851 can be formed such that a seam section spans or connects a boundary edge of a first PV panel and an edge region (not directly at the peripheral boundary edge) of a second PV panel. Furthermore, a “H” seam can be formed such that a seam section spans or connects two edge regions of two adjacent PV panels, but does not connect directly to peripheral edges of the PV panels.

The “z” seam 1801 may be referred to as a major fold back. The “z” seam 1801 may flash a penetration (e.g., a penetration for a fastener 1802 to attach the folding PV panel to the roof). The “z” seam 1801 may include the electrical conductor integrated into or separate from the “z” seam 1801. The “z” seam 1801 may be continuous along the width of the panel, or only in some sections.

The “k” seams 1851 may require separate electrical conductors that do not completely reside within the seam 1851 while the “z” seam 1801 may more likely employ electrical conductors between PV panels that completely reside within the seam 1801. The “z” seam 1801 may be considered a major fold back but lack a full shingle type look. The “k” seam 1851, comparatively, may lack the toughness of a complete fold back but may provide more of an overlapping shingle appearance. The microinverter or junction box is also shown at the top end of the PV modules. This microinverter, junction box, or other connection may be located at other positions or may be more fully integrated in embodiments.

The “k” seam 1851 may provide an overlapped front sheet section 1859. This section 1859 may include one or more cells or cell portions. This section 1859 may provide shadow lines and a shingle look. Also, an insulated conductor 1855 may be separate or integrated into the “k” seam 1851.

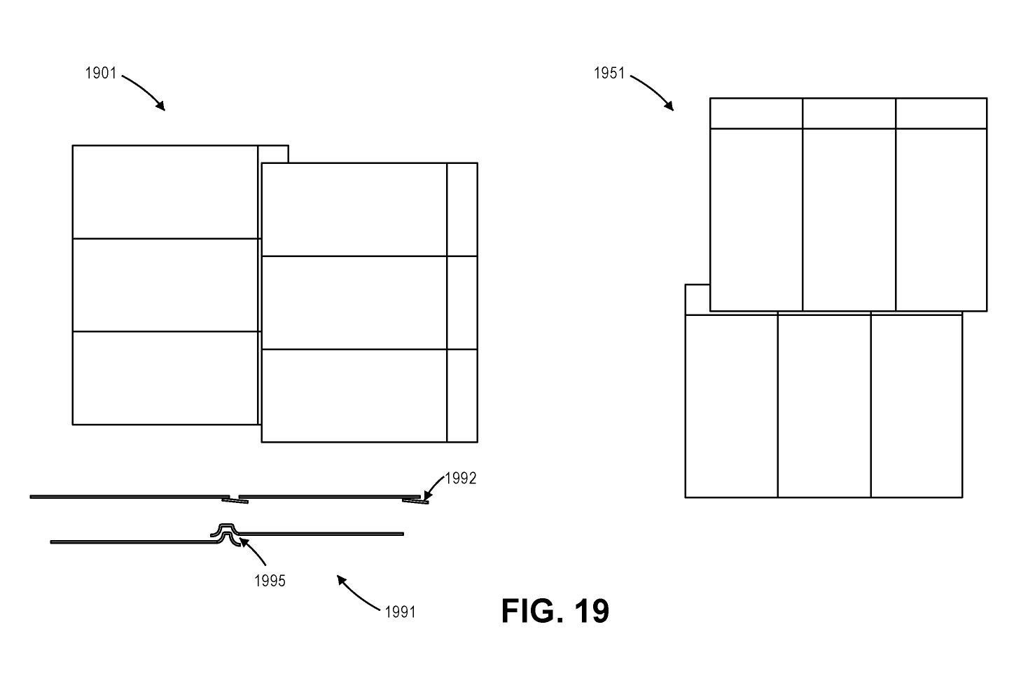

FIG. 19 illustrates how PV modules may be staggered in both the horizontal 1901 and/or vertical orientations 1951. FIG. 19 also illustrates folding PV panels 1991 with overlapping connections, where some may be simple overlaps 1992, e.g. a lap joint, while other may be congruent connections 1995, e.g. inverted corresponding channels nestled together. The congruent connections 1995 shown in FIG. 19 are in the approximate shape of inverted u-shaped furrows. Other shapes may also be employed in embodiments, for example, the congruent connections 1995 may also be in the shape of triangles, L-channels, crosses, tiered pyramids, etc. As mentioned above, the congruent connections 1995 may include aligners to assist in aligning adjacent PV panels to one another. The aligners may provide a positive stop or other mechanical, audible, or visual indication when two adjoining adjacent panels have reached their intended relevant connected positions.

The PV modules in orientation 1901 show East-West shingling while the PV modules in orientation 1951 show North-South shingling. The East-West shingling may be considered to be left right shingling orientations where adjacent PV modules may be at approximately the same elevation across a roofline or other installation location. The North-South shingling may be considered to be up-down shingling where PV modules sit approximately above or below one another up and down the slope of a roofline or other installation location. Lap joints and the congruent connections may be employed in both types of installations, i.e. North-South orientations and East-West installations. Congruent connections may be preferred where cabling is needed as the congruent connections may provide a channel within which the cabling can be run.

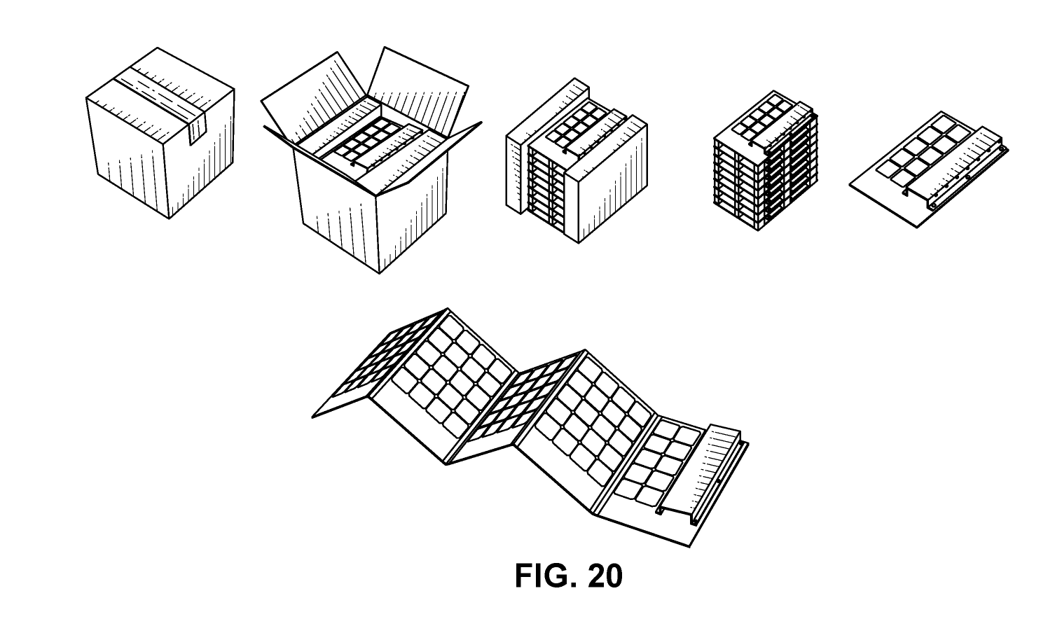

FIG. 20 illustrates how PV modules may be packaged and unpackaged in accord with embodiments. The PV module shown in the bottom of FIG. 20 includes five PV panels and a connection cover. The five panels may be folded back and forth upon each other with the connection cover being visible in the upper most panel. Several PV modules folded in this way may then be stacked upon each other and may be boxed for shipment. The upper series of illustrations in FIG. 20 shows how several PV modules may be boxed together, stacked upon each other, and then separated for later unfolding prior to installation at a job site. As can be seen, the folded PV modules may form the shape of a cuboid when one PV module is in a folded configuration and when several folded PV modules are stacked upon each other. Additional protective material, shown in blue, may also be used for protection during transportation of the boxed PV modules.

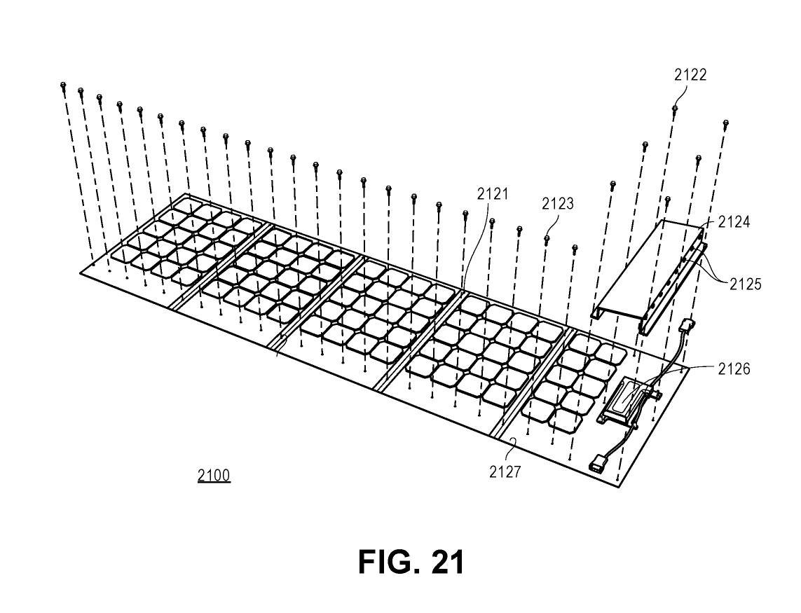

FIG. 21 illustrates a five PV panel PV module 2100 as may be employed in embodiments. The PV module 2100 includes five equally sized PV panels where one of the PV panels includes fewer PV cells than the other four. The space created by the missing PV cells is occupied by a microinverter 2126 and cover 2124 in FIG. 21 (which may be attached to the PV panel by fasteners 2122, such as screws). Other features labelled in FIG. 21, which may be employed in various embodiments, include the ventilation holes 2125 of the microinverter cover 2124, the roofing nail surface 2127 and the pre-punched holes 2121 for fasteners 2123, such as roofing nails. Various other mechanisms for attaching the PV module 2100 to a roof surface can be employed alone or in combination, for example adhesives can be employed to attach the PV module 2100 to the roof.

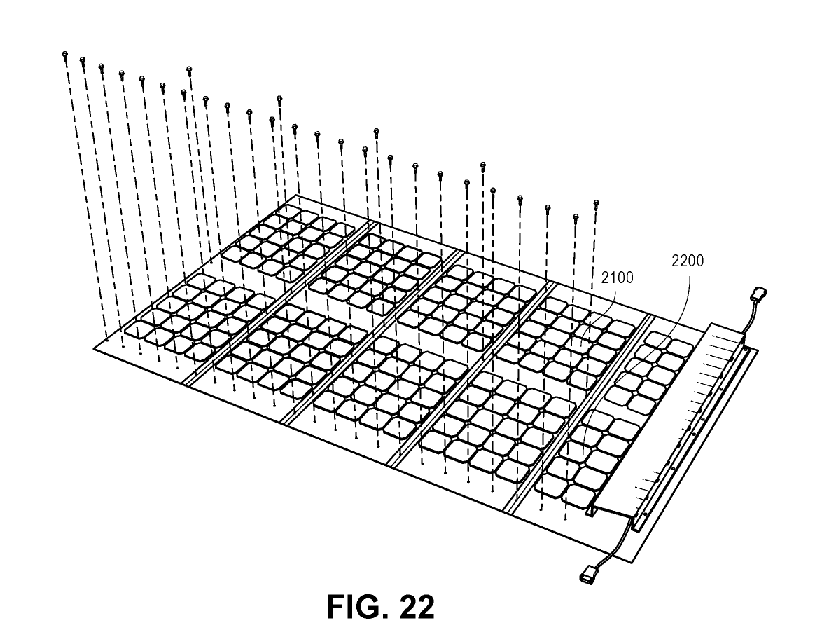

As can also be seen, the microinverter cover 2124 may be sized and positioned to cover one or microinverters 2126 as well as associated cabling. Moreover, the cover 2124 may be rectangular in shape, which can serve to assist in efficient packaging when a PV module 2100 is folded upon itself for transportation. FIG. 22 shows how the PV module 2100 may be coupled to a second PV module 2200. As can be seen, the inverter cover may be long enough to cover more than the width of one PV module 2100. Thus, an inverter cover may be installed during installation in some embodiments. As can also be seen, connectors for daisy chaining additional PV modules may emerge from one or both ends of the inverter cover. These connectors may be located in other locations as well in embodiments. For example, the connectors may emerge from the sides and top of the inverter cover as well as through the bottom of the PV modules 2100 and/or 2220. Punch-outs may be used in the inverter cover as well as the PV modules 2100 and/or 2200 to facilitate cabling access to and from components of the PV modules 2100 and/or 2200.

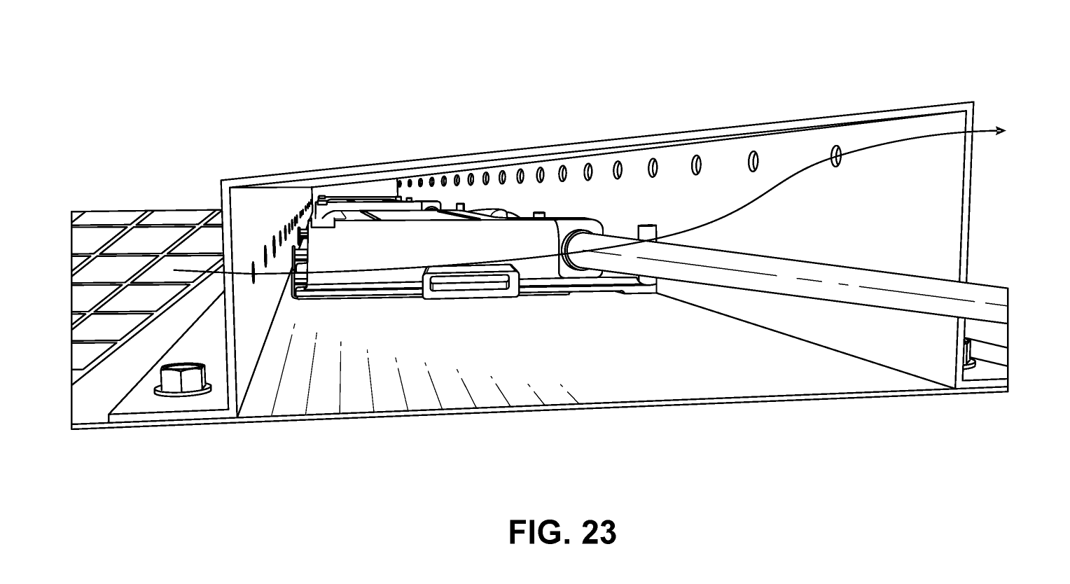

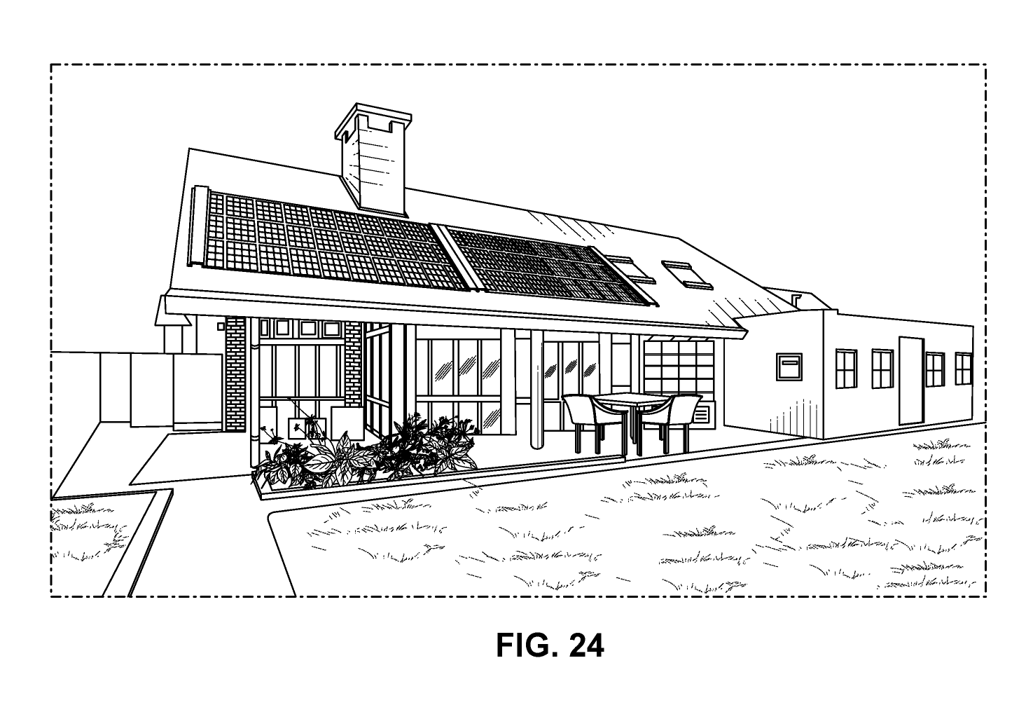

FIG. 23 shows an enlarged side perspective view of an end of a PV module with inverter cover and inverter, and inverter cable as may be employed in embodiments. As can be seen, there are holes on opposing sides of the inverter cover and the holes are spaced along the length of the inverter cover and are at different heights of the inverter cover. These holes may provide for airflow through the cover and around the inverter or other components located within the cover. The cable is shown emerging from an end of the cover. Other connection designs and locations may also be employed.

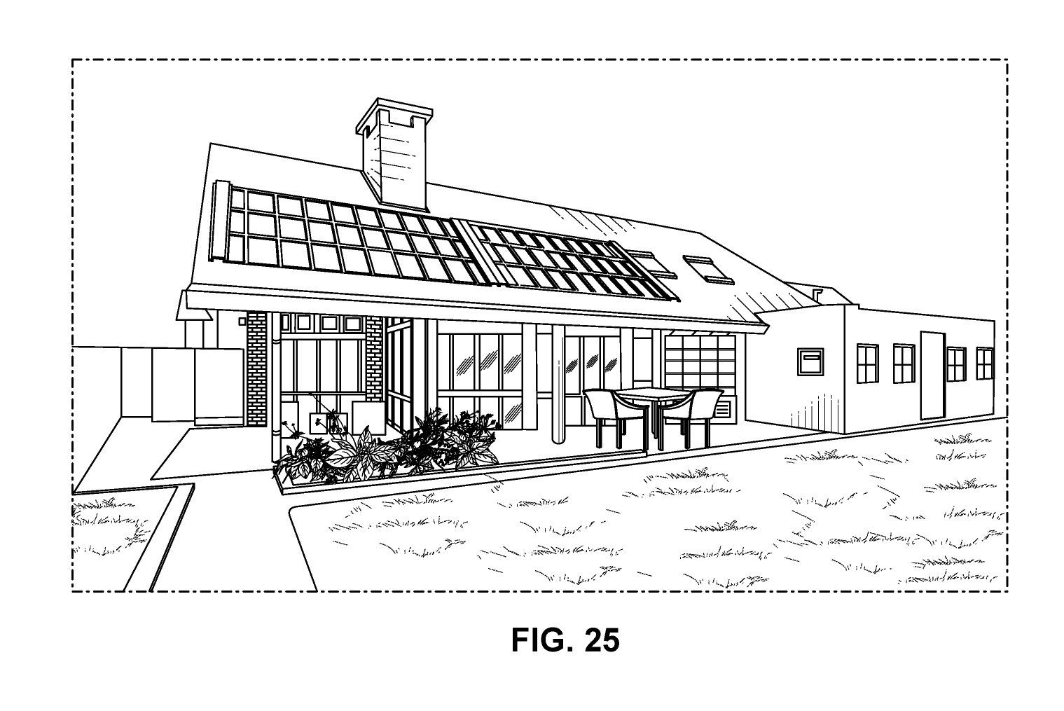

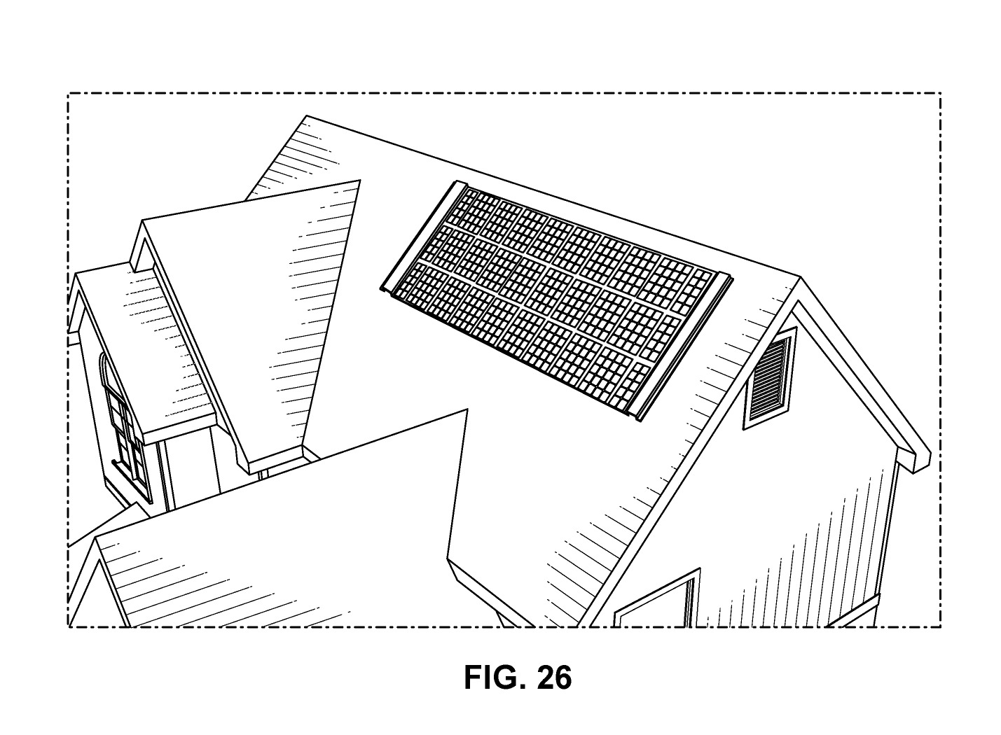

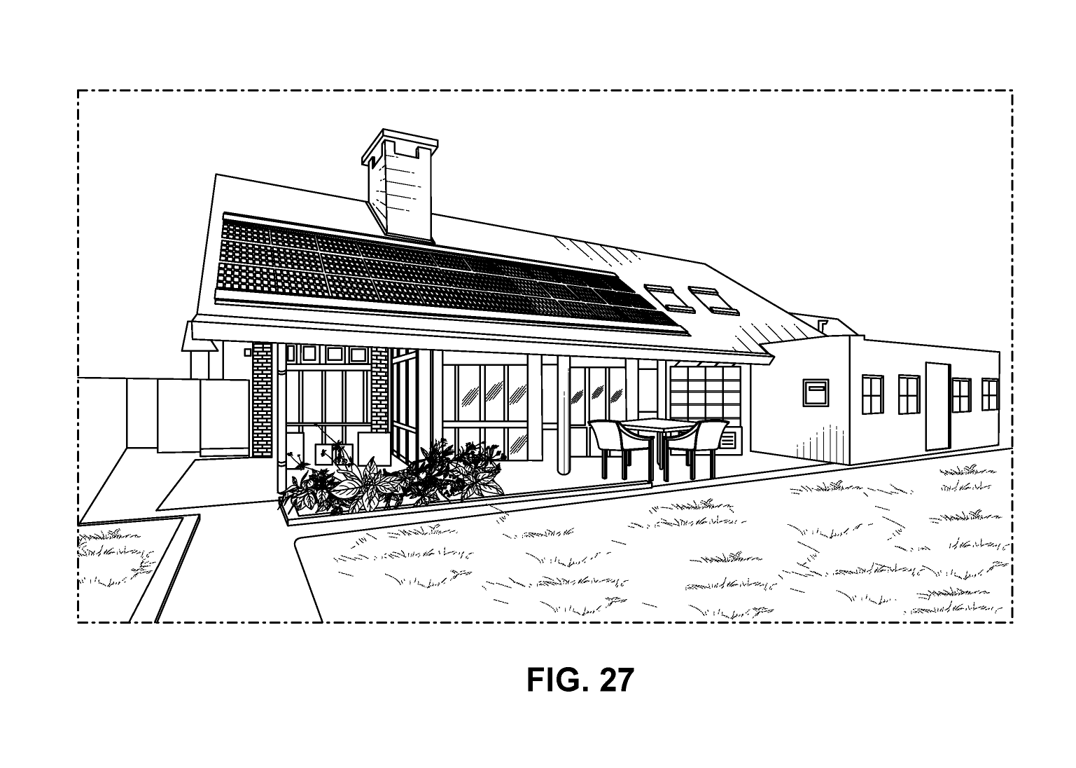

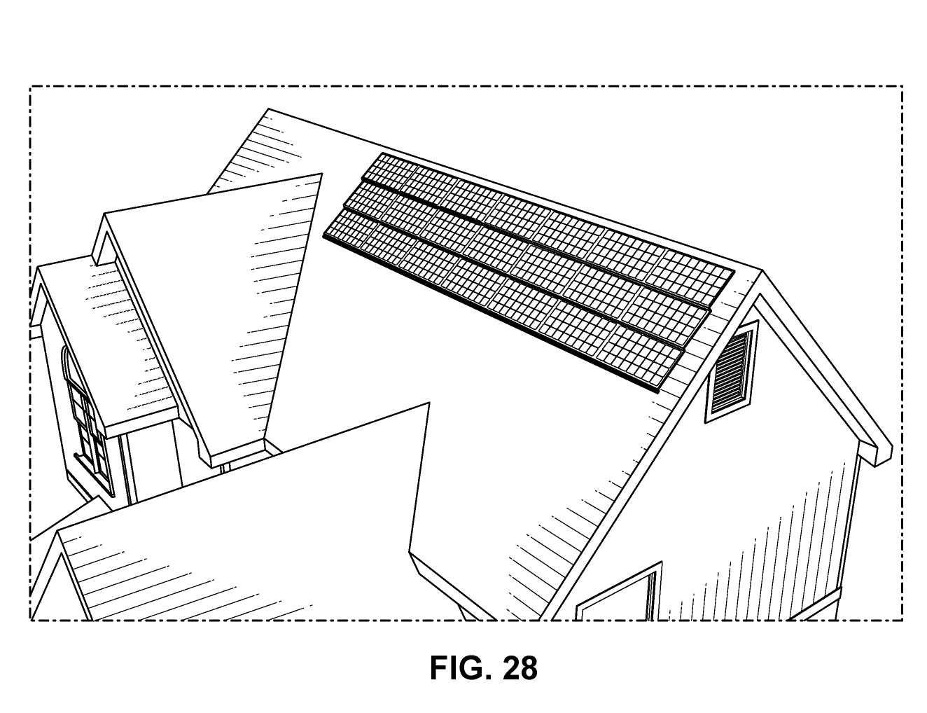

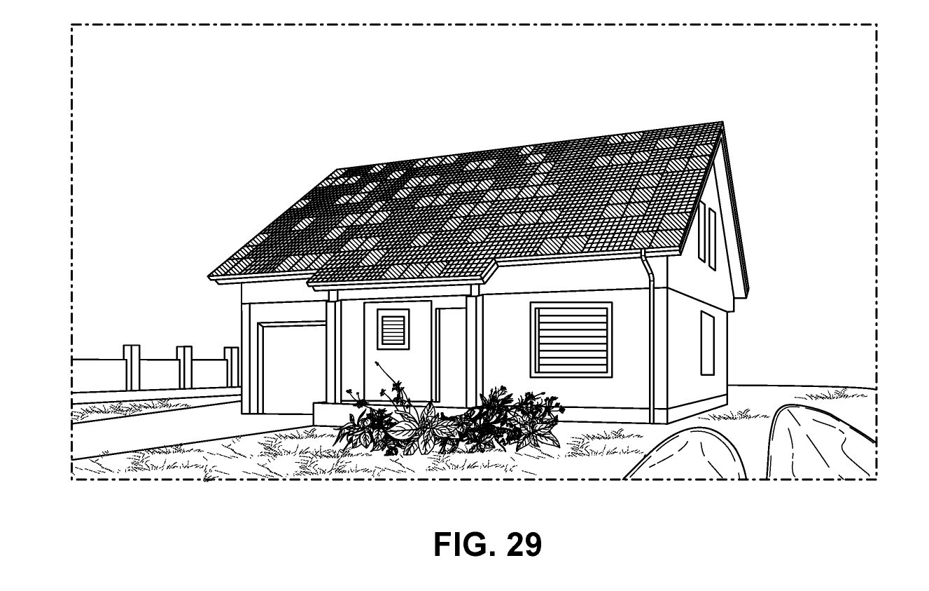

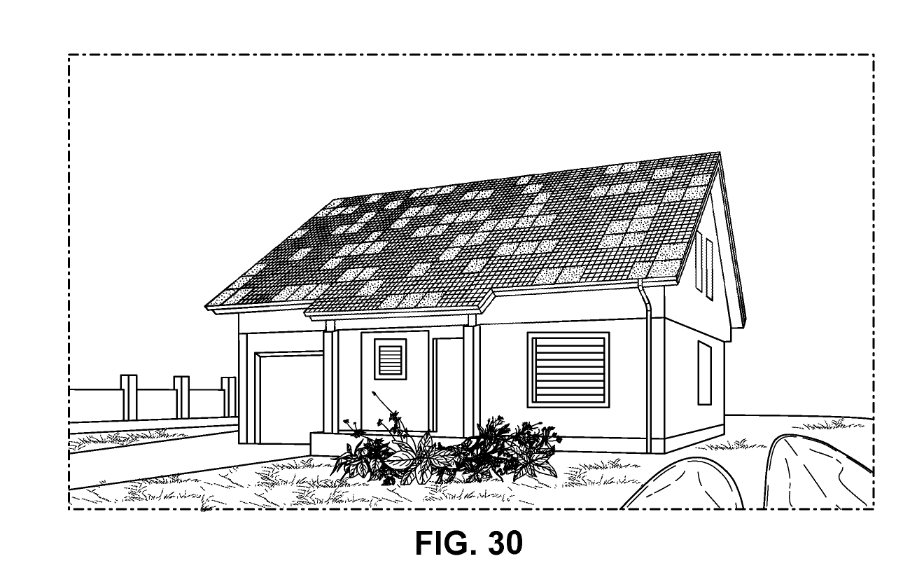

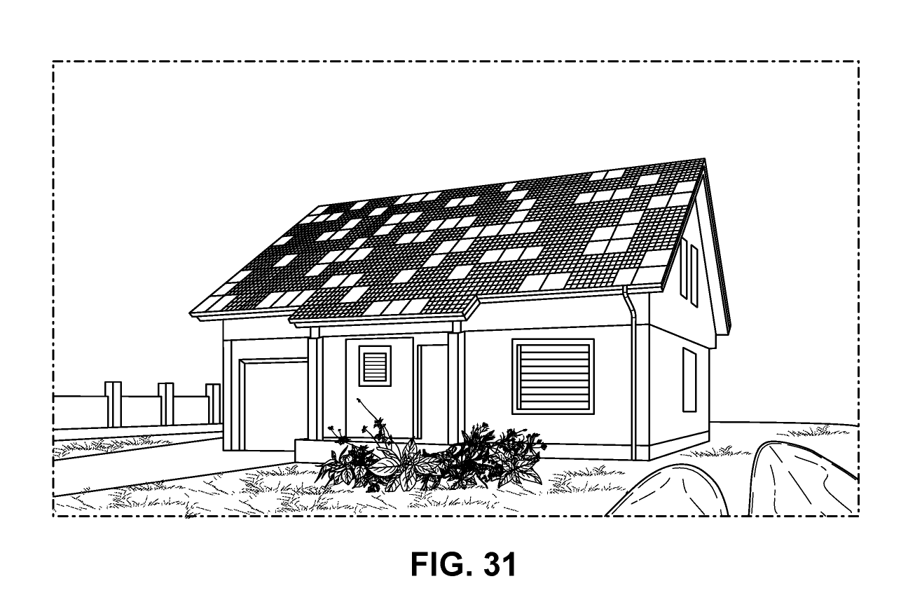

FIGS. 24-31 show roof mounting applications of PV modules in accord with embodiments. As can be seen, the modules may be adjoining each other and may be spaced apart as well. They may be joined to create various sized full arrays and various shapes and optical patterns. FIGS. 29-31 illustrate Tetris-like connection orientations of PV panels as may be employed in embodiments. As can be seen, series of two, three, four, five, six and more PV panels are connected as part of PV modules in FIGS. 29-31. Other numbers of PV panels making up PV modules may also be employed in embodiments.

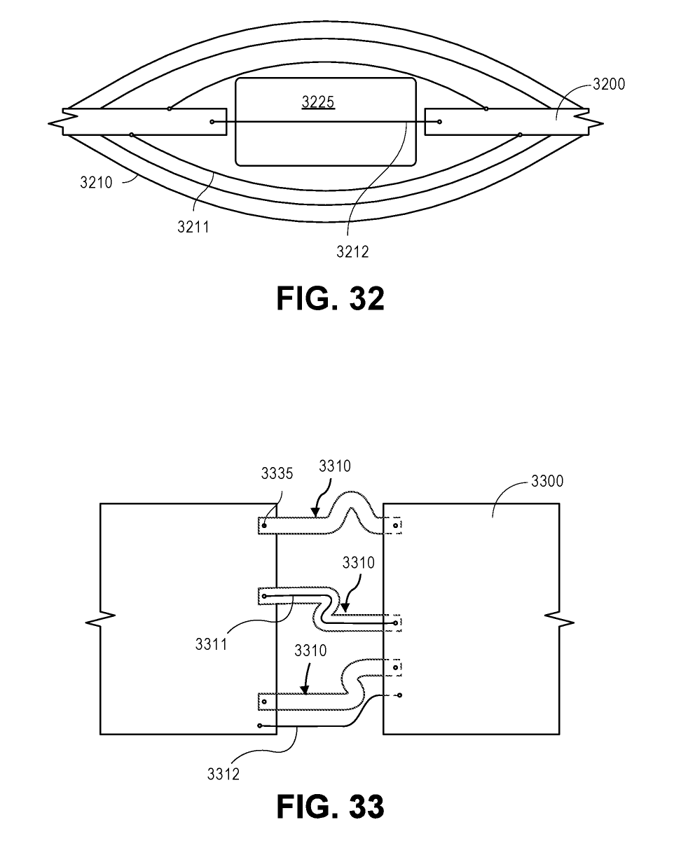

FIG. 32 shows a side view of a PV module 3200 being joined to another PV module with a continuous flexible seam 3210. The electrical conductor 3212 may pass through the central filler 3225 and/or an electrical conductor 3211 may pass around the central filler 3225 in various embodiments.

FIG. 33 shows how a PV module 3300 may be joined to another PV module by discontinuous seams or straps 3310 and how the electrical conductors 3311 and 3312 can be within the straps 3310 or outside of them, respectively. The straps 3310 may comprise nylon or carbon fiber reinforcement, or metallic, or composite or a polymer(s) or other tough fabric-like materials that can provide for flexibility during storage, unfolding, and installation and light weight. The straps 3310 may be pivotally attached by fastener 3335

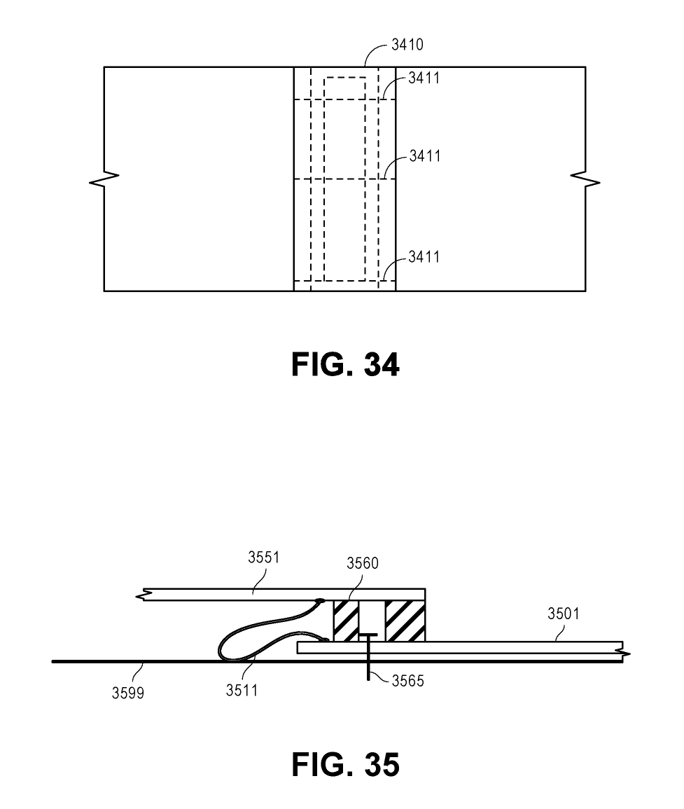

FIG. 34 shows a top down view of a continuous seam 3410, which may be similar to continuous seam 3210 FIG. 32. As can be seen, electrical conductors 3411 may be positioned at various locations along the edge and face of the PV modules.

FIG. 35 shows an end view of an assembly of PV module 3501 and PV module 3551 that may be secured elsewhere via a seam or strap. This portion shows how adhesive 3560 may secure the PV modules 3501 and 3551 together and how the PV modules 3551 may shingle over the PV module 3501. A fastener 1351 (e.g., a nail or screw) may be used to secure the PV module 3501 to the roof 3599 and the electrical conductor 3511 may reside outside of the adhesive area, be partially within the adhesive area, or lie within the adhesive area in embodiments.

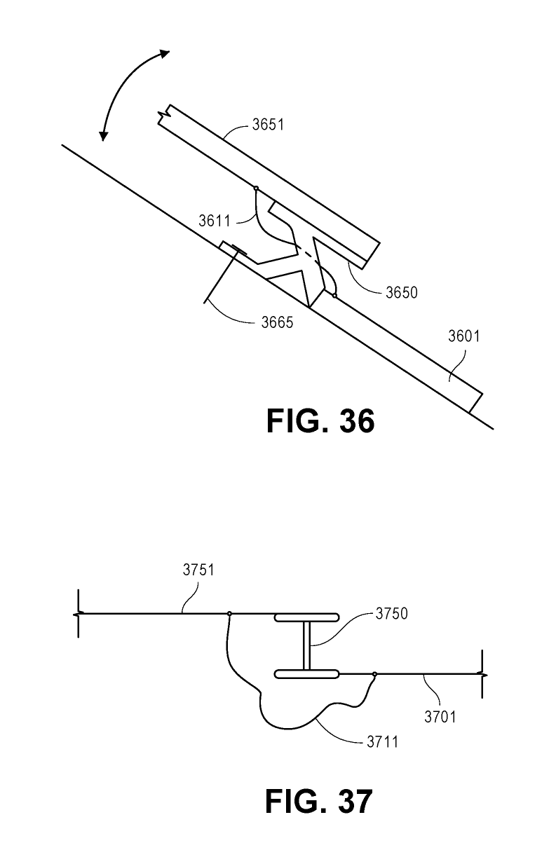

FIG. 36 shows a side sectional view of a K seam 3650 as may be employed in embodiments. As can be seen, the top PV module 3651 overlaps the lower PV module 3601. As can also be seen, the fastener 3665 may be placed through a portion of the K seam 3650 and the PV module 1651 may pivot about the K seam 3650 to allow for placement of the fastener 3665. The electrical conductor 3611 may pass around or through the K seam 3650 in embodiments and the K seam 3650 may lie along an entire edge or border of the PV module 3601 and/or PV module 3651 or only a portion of it, with a plurality of a K seams 3650 preferably employed when the seam is not continuous along the entire edge of the PV module 3601 and/or PV module 3651.

FIG. 37 shows an I seam 3750 (also referred to as an “H” seam) with PV module 3751 and PV module 3701. As can be seen, the top PV module 3751 lies across the entire top of the H seam 3750 while the bottom PV module 3701 is connected to an edge of the H seam 3750.

Embodiments may provide for a PV module with several panels interconnected by a seam or flexible region. The panels can be folded into a stacked configuration for shipment, which can decrease shipping costs and make handling of the folded subpanels easier. The folded panels can also enable easy transport of the panels from warehouses to job sites and from truck to roof. The PV module can be lightweight and can be mounted directly on a roof. For example, direct roof attachment may be enabled by placing a microinverter on a front side of the PV module, removing the frame, and/or by fabricating the PV module from lightweight materials, e.g., polymers.

In embodiments, the PV module can include several PV panels interconnected by a single or composite seam as well as by multiple seams. For example, the PV module may include a first PV panel having several PV cells arranged in an array to receive and convert sunlight into electrical energy. The PV module may also include a second PV panel having respective PV cells arranged in an array. The cell arrays can include any number of rows and columns of PV cells, e.g., four rows and eight columns of PV cells. Furthermore, the PV module can include any total number of PV cells, e.g., 60-96 total PV cells. In embodiments the number of cells per module may be 144 or more.

In embodiments, each PV panel of the PV module may include a front side facing the sun and a backside facing an installation site. For example, each PV panel may include a front sheet facing upward toward the sun, and a back sheet facing downward toward a roof. The back sheet of each subpanel may be mounted directly on the roof, as described herein.

The front sheet and back sheet of the PV panels may be planar. More particularly, each of the PV panels may extend along a respective lateral plane. For example, the first PV panel may extend along a first lateral plane, and the second PV panel may extend along a second lateral plane. The lateral planes may be separated by an angle. For example, when the PV module is folded about the seam, the angle between the PV panels may change. By way of example, when the second PV panel is folded upward about the hinge, the angle between the front sheet of the first PV panel and the front sheet of the second PV panel decreases. The seam may permit the angle between the first lateral plane and the second lateral plane to change. Accordingly, each of the PV panels in the PV module may be coupled to one or more adjacent PV panels by a respective seam or seams, and the seams may be in an open position to spread the PV panels for mounting, or the seams may be in a closed position for stacking the subpanels for shipment and handling.

The PV module may include other components mounted on the PV panels. For example, a housing or cover may be mounted on the first PV panel. More particularly, the housing may be mounted on the front side of the first subpanel. Furthermore, the housing may be mounted over another component, e.g., an electrical or electronic component, of the PV module. For example, the housing may be mounted over one or more of a microinverter or a junction box. As described herein, the microinverter or the junction box can be mounted on top of a PV panel.

The PV modules may be described as an alternating current type PV panel herein, however, the PV modules may have a different panel architecture. For example, the PV modules may have a direct current (DC) panel architecture. Accordingly, other components may be mounted in the housing. For example, a DC optimizer may be mounted on a top surface of the PV panel and may be enclosed within the housing.

In addition to housing an integrated microinverter, the housing may enclose electrical cables, e.g., alternating current or direct current cables, and connectors used to transfer electrical power between the PV cells and an electrical power distribution network. The housing can isolate and protect the various enclosed components from a surrounding environment. For example, the housing can provide a rain shield and flashing for water shedding. The housing may be a plastic or a metal enclosure having rounded edges, and may be colored to blend into an aesthetic of the roof on which the PV module or modules are mounted.

In embodiments, the housing can include wire management features. For example, the housing may include cable/connector or wire management features built into or attached to the enclosure. The features may keep components raised. More particularly, the features may hold the components at a location that is spaced apart from the first subpanel, or from other surfaces that may come into contact with water.

In embodiments, each PV panel, and optionally each seam of the PV module, may have all-polymer constructions. The all-polymer construction of the PV panels may exclude the PV cells, electrical interconnects, etc. More particularly, the all-polymer construction may refer to the laminate layers of the PV panels. Or, at least one or more of a front sheet or a back sheet of each PV panel may be fabricated from polymer, such as for example, glass-filled polymer. Accordingly, the PV panels and the PV module may be lightweight.

In embodiments, a PV panel may include a PV cell between a front sheet and a back sheet. The front sheet may be a thin glass or polymer layer. Such a construction may contrast with typical thick glass front sheets that are supported by frames. More particularly, the front sheet may be thin, polymeric, and/or frameless, and thus, the front sheet may be lightweight. In embodiments, the back sheet of the first subpanel may be a metal, polymer, glass, fiber-glass reinforced polymer, or polymer reinforced polymer.

The PV cell may be any PV cell type. For example, the PV cell may be an interdigitated back contact cell, a front contact cell having overlapping cell sections, or a front contact cell. More particularly, the PV cell may be any known PV cell for converting insolation into electrical energy. In an embodiment, the first subpanel includes a first encapsulant layer between the front sheet and the PV cell. The first encapsulant layer may be formed from an encapsulant material. For example, the encapsulant material may harden after curing to form a thin transparent film between the front sheet and the PV cell. Similarly, the first subpanel may include a second encapsulant layer between the PV cell and the back sheet. Accordingly, the PV cell may be encapsulated between the front sheet and the back sheet to form a frameless and lightweight first subpanel that can be mounted directly on a roof. The second subpanel may have a similar construction, e.g., including a respective PV cell between a respective front sheet and a respective back sheet. Thus, each PV panel of the PV module may be a lightweight laminate, and the PV module may be easy to handle and have a high wattage per pound ratio. By way of example, the PV module may be configured to generate 100 W to 1 kW of electrical energy, and may have a total weight of 35 pounds or less.

One or more electrical or electronic components may be integrated in the laminate structure of a PV panel in embodiments. For example, a diode may be mounted on or in a PV panel. The diode may be disposed between the front sheet and the back sheet of the PV panel, e.g., within one of the encapsulant layers. Accordingly, an inlaminate diode may provide diode protection for the PV module. Also, a diode may be mounted within the junction box to provide diode protection for the folding PV panel.

In embodiments, the seal may take on a “k” like or “H” like cross-sectional shape. The seams may have a first leaf connected to the first PV panel, and a second leaf connected to the second PV panel. The first leaf and the second leaf may move relative to each other via a flexible or rotatable coupler or another seam configuration. In embodiments, the seam may include a flexible strap, and the first leaf and the second leaf may be sections of the flexible strap. The flexible strap can be fabricated from a strip or film of flexible material, e.g., a fiber reinforced rubber, a composite film, etc. The seam can also be formed as part of a laminate during a lamination process or added afterwards. The seam can have insulators for the electrical components. The insulators can be laminated or mounted after the lamination process is complete.

In embodiments, the flexible strap or straps can include a central portion integral to the first leaf and the second leaf. The first leaf, the second leaf, and the central portion may be sections of the flexible strap defined by their placement relative to the subpanels of the PV module. The first leaf may be the section of the flexible strap mounted on the first subpanel, the second leaf may be the section of the flexible strap mounted on the second subpanel, and the central portion may be the section of the flexible strap that bridges a gap between the first subpanel and the second subpanel. Each leaf of a seam can be attached to a respective subpanel using a mechanical, adhesive, or thermal bond. For example, the leaves may be fastened to the PV panels by screws, the leaves may be glued to the PV panels, or the leaves may be welded to the PV panels.

Electrical or electronic components may be mounted on the seams. For example, an electrical wire, such as a wire of an electrical ribbon, may traverse a length and/or width of the hinge. The electrical wire may be attached to the seam, e.g., by being laminated onto the seam. The electrical wire may provide a conductive return to transfer electrical power from the PV cell to the microinverter or the junction box. Other electrical or electronic components, such as the diode described above or conductive ribbons, may be mounted on the hinge, e.g., within the gap between the first subpanel and the second subpanel. The seam may also have an encapsulant or another insulation to isolate and protect the ribbon from the environment. The electrical wire and/or electronic components can run along or across the seam. For example, the electrical wire may run in any direction (longitudinally through the gap, transversely across the gap, slanted across the gap, vertically through the hinge, etc.) across the hinge to electrically interconnect a PV cell of the first subpanel with a PV cell of the second PV panel. The electronic components can be disposed within the seam or outside of the seam to interconnect the respective panels.

In the stacked configuration, a PV module may have a compact form factor. In embodiments, a PV module may occupy an envelope having a length of 48 inches or less, a width of 22 inches or less, and a thickness of 3 inches or less. A total weight of a PV module may be less than 50 pounds, e.g., 20 pounds. Thus, in certain embodiments, a PV module may be easily carried.

To facilitate handling, a carrying strap may be wrapped around a folded PV module and secured to retain the folded PV module in the stacked configuration during shipment and handling. A handle may be attached to the carrying strap to allow an installer to easily pick up the folded PV module as a bundle. As described above, the bundle of stacked PV panels can have a 1 kW power generation capacity. In an embodiment, more than one folded PV modules can be strapped together to be carried as a single unit. For example, several folded PV modules may be bundled together by a securing strap, and the bundle of panels can be carried on a back of an installer, e.g., as a backpack.

Several folded PV panels may be shipped on a single shipping pallet. By way of example, a package of PV panels may include four folded PV modules stacked and nested on a pallet. The package can include a first stack of two folded PV modules stacked on the pallet next to a second stack of two folded PV modules. Each stack of PV modules can include one or more integrated microinverters between the subpanels of the stacked folded panels. For example, a microinverter mounted on the first PV panel of a bottom folded PV module may support the first PV panel of a top folded PV module, and a microinverter mounted on the first PV panel of the top folded PV module may rest on the first PV panel of the bottom folded PV module. In other words, in embodiments, the integrated microinverters can mechanically space and separate the stacked folded PV modules. Other components may be stacked on or between the folded PV panels. For example, the package may include a component box having the housings, flashing, wiring, etc., used to complete installation of the unfolded PV modules at the installation site.

In embodiments, a pallet can have a total power generation capacity of 4 kW and weigh 160 pounds, and thus, the package of folded PV modules may provide an inexpensive and efficient shipping and handling solution. That is, embodiments may provide an improved module logistics solution. The improved module logistics solution may also be efficiently implemented by distributors that do not ordinarily participate in the solar power market. For example, the PV modules may be sold and distributed by online retailers because the shipping and handling may be simplified compared to other PV module and racking system solutions.

In embodiments, a microinverter and/or the junction box may be electrically connected to other components of the PV module. For example, one or more of the microinverter or the junction box may be electrically connected to the electrical wire routed along the seam. That is, the electrical wire may return electrical power from the PV cells to the microinverter or the junction box within the housing. The microinverter or the junction box may be electrically grounded to other components of a PV module. For example, the housing may be fabricated from metal, and thus, the microinverter may be electrically grounded to the housing by a grounding cable. That is, the grounding cable may have a first end attached to a microinverter and are and a second end attached to the housing, e.g., by a screw. Similarly, the back sheet of a PV panel may be fabricated from metal, and thus, the microinverter or the junction box can be electrically grounded to the back sheet by the grounding cable or a conductive coupling, such as a screw.

It will be understood that the sequential arrangement of PV panels along a single longitudinal axis is not limiting and other arrangements are possible. For example, a PV panel may have a first seam along a first edge and a second seam along a second edge orthogonal to the first edge. The first seam may interconnect the second PV panel with the first PV panel in a first direction, and the second hinge may interconnect the second PV panel with a third PV panel in a second direction orthogonal to the first direction. Accordingly, the first, second, and third PV panels may be arranged in an “L” pattern. The panels and seams can be in one or two directions, and PV panels may be interconnected to any edge of an adjacent subpanel to form different arrangement patterns, such as a “Z” or an “O” pattern.

### EXAMPLES

Example A1 is a folding photovoltaic (PV) panel, comprising: a first subpanel including a first PV cell between a first front sheet and a first back sheet, wherein the first subpanel extends along a first lateral plane; a second subpanel including a second PV cell between a second front sheet and a second back sheet, wherein the second subpanel extends along a second lateral plane; and a hinge having a first leaf and a second leaf, wherein the first leaf is coupled to the first subpanel and the second leaf is coupled to the second subpanel to allow an angle between the first lateral plane and the second lateral plane to change.

Example A2 includes the subject matter of example A1, or any other example herein, wherein the first subpanel includes a first encapsulant layer between the first front sheet and the first PV cell, and wherein the first subpanel includes a second encapsulant layer between the first PV cell and the first back sheet.

Example A3 includes the subject matter of any of examples A1-A2 (e.g., example A2), or any other example herein, wherein one or more of the first subpanel or the second subpanel have an all-polymer construction.

Example A4 includes the subject matter of any of examples A1-A3 (e.g., example A2), or any other example herein, further comprising a diode between the first front sheet and the first back sheet.

Example A5 includes the subject matter of any of examples A1-A4 (e.g., example A1), or any other example herein, further comprising an electrical wire on the hinge.

Example A6 includes the subject matter of any of examples A1-A5 (e.g., example A5), or any other example herein, further comprising one or more of a microinverter or a junction box mounted on the first subpanel, wherein the one or more of the microinverter or the junction box are electrically connected to the electrical wire.

Example A7 includes the subject matter of any of examples A1-A6 (e.g., example A6), or any other example herein, further comprising a housing mounted on the first subpanel over the microinverter.

Example A8includes the subject matter of any of examples A1-A7 (e.g., example A7), or any other example herein, wherein the microinverter is electrically grounded to one or more of the housing or the first back sheet.

Example A9 includes the subject matter of any of examples A1-A8 (e.g., example A8), or any other example herein, wherein the housing includes a first housing section having a first height above the first subpanel and a second housing section having a second height above the first subpanel, and wherein the first height is different than the second height.

Example A10 includes the subject matter of any of examples A1-A9 (e.g., example A1), or any other example herein, wherein the hinge includes a flexible strap including the first leaf, the second leaf, and a central portion integral to the first leaf and the second leaf.

Example A11 includes the subject matter of any of examples A1-A10 (e.g., example A1), or any other example herein, wherein the hinge includes a knuckle coupled to the first leaf, and a pin coupled to the second leaf, wherein the pin is in the knuckle.

Example A12 includes the subject matter of any of examples A1-A11 (e.g., example A1), or any other example herein, wherein the hinge is a living hinge between the first subpanel and the second subpanel.

Example A13 includes the subject matter of any of examples A1-A12 (e.g., example A1), or any other example herein, wherein the first subpanel and the second subpanel are mounted directly on a roof

Example A14 includes the subject matter of any of examples A1-A13 (e.g., example A13), or any other example herein, wherein the first subpanel and the second subpanel are mounted in a portrait orientation or a landscape orientation.

Example A15 includes the subject matter of any of examples A1-A15 (e.g., example A14), or any other example herein, further comprising a shim having a first edge and a second edge, wherein the first edge is coupled to the first subpanel, and wherein the second edge is mounted between a pair of shingles of the roof.

Example B1 is a modular photovoltaic module comprising: a first two-dimensional array of photovoltaic cells positioned on a first panel, the first panel having at least one side border; a second two-dimensional array of photovoltaic cells positioned on a second panel, the second panel having at least one side border; and a flexible seam connecting the first panel to the second panel, wherein the flexible seam is configured such that the first panel and the second panel may be stacked upon one another in a first configuration and the first panel and the second panel may overlap one another along panel side borders in a second configuration.

Example B2 include the subject matter of example B1, or any other example herein, further comprising: an inverter, the inverter electrically connected so as to receive DC voltage from photovoltaic cells of at least the first two-dimensional array or the second two-dimensional array.

Example B3 includes the subject matter of any of examples B1-B2 (e.g., example B1), or any other example herein, wherein the flexible seam connects an edge of the first panel to an edge of the second panel.

Example B4 includes the subject matter of any of examples B1-B3 (e.g., example B1), or any other example herein, wherein the flexible seam and the first panel and the second panel form a cross-section having a “K” shape or an “H” shape.

Example B5 includes the subject matter of any of examples B1-B4 (e.g., example B1), or any other example herein, wherein the flexible seam connects a top or bottom surface of the first panel to a top or bottom surface of the second panel.

Example B6 is a multi-panel photovoltaic module comprising: a first array of photovoltaic cells on a first panel, the first panel having at least three sides; a second array of photovoltaic cells on a second panel, the second panel having at least three sides; a third array of photovoltaic cells on a third panel, the third panel having at least three sides, wherein the first panel and the second panel are connected to each other by a first seam, wherein the second panel and the third panel are connected to each other by a second seam, the first seam configured such that the first panel and the second panel may be stacked upon one another in a first configuration and the first panel and the second panel may overlap one another along a side border in a second configuration, the second seam configured such that the second panel and the third panel may be stacked upon one another in the first configuration and the second panel and the third panel may overlap one another along a side border in the second configuration.

Example B7 includes the subject matter of example B6, or any other example herein, wherein the first seam is configured such that the first panel and the second panel may be uniformly stacked upon one another in a cuboid configuration and, wherein the second seam configured such that the second panel and the third panel may be uniformly stacked upon one another in a cuboid configuration.

Example B8 includes the subject matter of any of examples B6-B7 (e.g., example B6), or any other example herein, further comprising a microinverter electrically coupled to at least the first array of photovoltaic cells on the first panel or second array of photovoltaic cells on the second panel or third array of photovoltaic cells on the third panel.

Example B9 includes the subject matter of any of examples B6-B8 (e.g., example B6), or any other example herein, wherein the first array of photovoltaic cells on the first panel the second array of photovoltaic cells on the second panel and the third array of photovoltaic cells on the third panel as removably positioned inside of a shipping box.

Example B10 includes the subject matter of any of examples B6-B9 (e.g., example B6), or any other example herein, further comprising a microinverter electrically coupled to at least the first array of photovoltaic cells on the first panel or second array of photovoltaic cells on the second panel or third array of photovoltaic cells on the third panel, wherein the microinverter is secured to at least one of the first panel, the second panel, or the third panel, wherein the third array of photovoltaic cells on the third panel contains fewer photovoltaic cells than the first array of photovoltaic cells on the first panel and the second array of photovoltaic cells on the second panel contains fewer photovoltaic cells than the first array of photovoltaic cells on the first panel and the second array of photovoltaic cells on the second panel.

Example B11 is a folding photovoltaic (PV) panel, comprising: a first subpanel including first PV cells between a first front sheet and a first back sheet, wherein the first subpanel extends along a first lateral plane; a second subpanel including second PV cells between a second front sheet and a second back sheet, wherein the second subpanel extends along a second lateral plane; and a hinge assembly having a first section, a second section, and a third section between the first and second sections, wherein the first section is coupled to the first subpanel and the second section is coupled to the second subpanel to allow an angle between the first lateral plane and the second lateral plane to change.

Example B12 includes the subject matter of example B11, or any other example herein, wherein the hinge assembly is foldable in a first configuration in which the first subpanel panel and the second subpanel form a stack, wherein in the stack a first side of the first subpanel faces a first side of the second subpanel, and a second configuration in which an edge of a second opposite side of the first subpanel overlaps an edge of the first side of the second subpanel.

Example B13 includes the subject matter of any of examples B11-B12 (e.g., example B12) or any other example herein, wherein, in the second configuration, an angle between the first section and the third section comprises an acute angle and an angle between the second section and the third section comprises an acute angle.

Example B14 includes the subject matter of any of examples B11-B13 (e.g., example B12) or any other example herein, wherein the first section of the hinge assembly is attached to the first subpanel differently than the second section of the hinge assembly is attached to the second subpanel.

Example B15 includes the subject matter of any of examples B11-B14 (e.g., example B12) or any other example herein, wherein the first section of the hinge assembly is attached to only the second side of the first subpanel and the second section of the hinge assembly is attached to only the first side of the second subpanel.

Example C1 is a folding photovoltaic (PV) panel, comprising: a first subpanel including a first PV cell between a first front sheet and a first back sheet, wherein the first subpanel extends along a first lateral plane; a second subpanel including a second PV cell between a second front sheet and a second back sheet, wherein the second subpanel extends along a second lateral plane; a hinge assembly having a first section, a second section, and a third section between the first and second sections, wherein the first section is coupled to the first subpanel and the second section is coupled to the second subpanel to allow an angle between the first lateral plane and the second lateral plane to change; and at least one electrical conductor extending from the first subpanel to the second subpanel, wherein the at least one electrical conductor is located in the hinge assembly or in a cabling assembly bridging a channel defined by edges of the first and second subpanels and the third section of the hinge assembly.

Example C2 includes the subject matter of example C1, or any other example herein, wherein the cabling assembly is located in a bottom of the channel.

Example C3 includes the subject matter of any of examples C1-C2 (e.g., example C2) or any other example herein, further comprising an adhesive located in the bottom of the channel, wherein the cabling assembly is mounted on the adhesive.

Example C4 includes the subject matter of any of examples C1-C3 (e.g., example C2) or any other example herein, wherein the cabling assembly is in contact with the hinge assembly.

Example C5 includes the subject matter of any of examples C1-C4 (e.g., example C2) or any other example herein, further comprising a gap between the cabling assembly and the hinge assembly.

Example C6 includes the subject matter of any of examples C1-C5 (e.g., example C1) or any other example herein, wherein the at least one electrical conductor or the cabling assembly bisects the channel.

Example C7 includes the subject matter of any of examples C1-C6 (e.g., example C1) or any other example herein, wherein the electrical conductor extends into the edges of the first and second subpanels.

Example C8 includes the subject matter of any of examples C1-C7 (e.g., example C7) or any other example herein, further comprising a seal surrounding the electrical conductor, the electrical conductor and the seal extending into the edges of the first and second subpanels.

Example C9 includes the subject matter of any of examples C1-C8 (e.g., example C7) or any other example herein, wherein the electrical conductor includes a first section that extends into the edge of the first subpanel, a second section that extends into the edge of the second subpanel, and a third section between the first and second sections of the electrical conductor, and wherein the PV panel further comprises an insulator surrounding only the third section of the electrical conductor.

Example C10 includes the subject matter of any of examples C1-C9 (e.g., example C1) or any other example herein, wherein the hinge assembly comprises a first hinge assembly and the first and second sections of the first hinge assembly are coupled to a first side of the first subpanel and a first side of the second subpanel, respectively, and wherein the folding PV panel further comprises: a second hinge assembly having a first section, a second section, and a third section between the first and second sections of the second hinge assembly, wherein the first and second sections of the second hinge assembly are coupled to a second side of the first subpanel and a second side of the second subpanel, respectively; wherein the channel is defined by the third section of the first hinge assembly, the edges of the first and second subpanels, and the third section of the second hinge assembly.

Example C11 includes the subject matter of any of examples C1-C10 (e.g., example C1) or any other example herein, wherein the hinge assembly includes a plurality of discrete hinges.

Example C12 includes the subject matter of any of examples C1-C11 (e.g., example C11) or any other example herein, wherein a gap between a first discrete hinge of the plurality of discrete hinges and a second discrete hinge of the plurality of discrete hinges exposes a portion of the channel, and wherein the cabling assembly is located in the exposed portion of the channel.

Example C13 includes the subject matter of any of examples C1-C12 (e.g., example C1) or any other example herein, wherein the hinge assembly includes a single continuous hinge.

Example C14 includes the subject matter of any of examples C1-C13 (e.g., example C1) or any other example herein, wherein the hinge assembly comprises a seam formed of one or more flexible layers.

Example C15 includes the subject matter of any of examples C1-C14 (e.g., example C14) or any other example herein, wherein the one or more flexible layers comprises laminated layers and the at least one electrical conductor is embedded in the laminated layers.

Example C16 includes the subject matter of any of examples C1-C15 (e.g., example C1) or any other example herein, wherein the hinge assembly comprises a first component and a second component rotatably coupled to the first component.

Example C17 includes the subject matter of any of examples C1-C16 (e.g., example C1) or any other example herein, further comprising an encapsulating layer filling the channel, wherein the at least one electrical conductor is embedded in the encapsulating layer.

Example C18 includes the subject matter of any of examples C1-C17 (e.g., example C1) or any other example herein, wherein a length of a portion of the cabling assembly spanning across the channel is different than a length of the third section of the hinge assembly, or a length of the at least one electrical conductor located in the cabling assembly is different than a length of the third section of the hinge assembly or the length of the portion of the cabling assembly.

Example C19 includes the subject matter of any of examples C1-C18 (e.g., example C17) or any other example herein, wherein the at least one electrical conductor is non-parallel with a bottom of the channel.

Example C20 includes the subject matter of any of examples C1-C19 (e.g., example C1) or any other example herein, wherein the at least one electrical conductor includes an intentional kink, a cut out, or a jog region.

Example C21 includes the subject matter of any of examples C1-C20 (e.g., example C1) or any other example herein, wherein the cabling assembly comprises a ribbon or a cable.

Example C22 includes the subject matter of any of examples C1-C21 (e.g., example C1) or any other example herein, wherein the folding PV panel comprise a self-shingling folding PV panel, wherein at least a portion of each of the back sheets is contact with a roof, and wherein the first and second subpanels are laying in a same plane.

Example C23 includes the subject matter of any of examples C1-C22 (e.g., example C1) or any other example herein, wherein the folding PV panel comprise a self-shingling folding PV panel, wherein at least a portion of each of the back sheets is contact with a roof, and wherein the first and second subpanels are laying in different planes.

Example C24 includes the subject matter of any of examples C1-C23 (e.g., example C23) or any other example herein, wherein the hinge assembly comprises a folded back seam or a recessed seam.

Example C25 is a folding photovoltaic (PV) panel, comprising: a first subpanel including a first PV cell between a first front sheet and a first back sheet, wherein the first subpanel extends along a first lateral plane; a second subpanel including a second PV cell between a second front sheet and a second back sheet, wherein the second subpanel extends along a second lateral plane; a hinge assembly having a first section, a second section, and a third section between the first and second sections, wherein the first section is coupled to the first subpanel and the second section is coupled to the second subpanel to allow an angle between the first lateral plane and the second lateral plane to change; and at least one electrical conductor extending from the first subpanel to the second subpanel, wherein the at least one electrical conductor is located in a cabling assembly bridging a channel defined by edges of the first and second subpanels and the third section of the hinge assembly.

Example C26 includes the subject matter of any of example C25 or any other example herein, further comprising a gap between the cabling assembly and the hinge assembly.

Example C27 includes the subject matter of any of examples C25-C26 (e.g., example C25) or any other example herein, wherein the hinge assembly comprises a first hinge assembly and the first and second sections of the first hinge assembly are coupled to a first side of the first subpanel and a first side of the second subpanel, respectively, and wherein the folding PV panel further comprises: a second hinge assembly having a first section, a second section, and a third section between the first and second sections of the second hinge assembly, wherein the first and second sections of the second hinge assembly are coupled to a second side of the first subpanel and a second side of the second subpanel, respectively; wherein the channel is defined by the third section of the first hinge assembly, the edges of the first and second subpanels, and the third section of the second hinge assembly.

Example C28 includes the subject matter of any of examples C25-C27 (e.g., example C25) or any other example herein, wherein a length of a portion of the cabling assembly spanning across the channel is different than a length of the third section of the hinge assembly, or a length of the at least one electrical conductor located in the cabling assembly is different than a length of the third section of the hinge assembly or the length of the portion of the cabling assembly.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A folding photovoltaic (PV) panel, comprising:
a first subpanel including first PV cells between a first front sheet and a first back sheet, wherein the first subpanel extends along a first lateral plane;
a second subpanel including second PV cells between a second front sheet and a second back sheet, wherein the second subpanel extends along a second lateral plane;
a hinge assembly having a first section, a second section, and a third section between the first and second sections, wherein the first section is coupled to the first subpanel and the second section is coupled to the second subpanel to allow an angle between the first lateral plane and the second lateral plane to change; and
at least one electrical conductor extending from the first subpanel to the second subpanel, wherein the at least one electrical conductor is located in the hinge assembly bridging a channel defined by edges of the first and second subpanels and the third section of the hinge assembly.

2. The folding PV panel of claim 1, wherein the first PV cells are further between first polymer layers, the first polymer layers between the first front sheet and the first back sheet, and wherein the second PV cells are further between second polymer layers, the second polymer layers between the second front sheet and the second back sheet.

3. The folding PV panel of claim 1, further comprising a microinverter or a junction box mounted on one or more of the sheets.

4. The folding PV panel of claim 3, wherein the microinverter is mounted on one of the back sheets.

5. The folding PV panel of claim 1, wherein the cabling assembly is located in a bottom of the channel.

6. The folding PV panel of claim 1, wherein the cabling assembly is in contact with the hinge assembly.

7. The folding PV panel of claim 1, further comprising a gap between the cabling assembly and the hinge assembly.

8. The folding PV panel of claim 1, wherein the at least one electrical conductor or the cabling assembly bisects the channel.

9. The folding PV panel of claim 1, wherein the hinge assembly includes a plurality of discrete hinges.

10. The folding PV panel of claim 9, wherein a gap between a first discrete hinge of the plurality of discrete hinges and a second discrete hinge of the plurality of discrete hinges exposes a portion of the channel, and wherein the cabling assembly is located in the exposed portion of the channel.

11. The folding PV panel of claim 1, wherein the hinge assembly includes a single continuous hinge.

12. The folding PV panel of claim 1, further comprising an encapsulating layer filling the channel, wherein the at least one electrical conductor is embedded in the encapsulating layer.

13. A folding photovoltaic (PV) panel, comprising:
a first subpanel including a first set of PV cells between a first front sheet and a first back sheet, wherein the first subpanel extends along a first lateral plane;
a second subpanel including a second set of PV cells between a second front sheet and a second back sheet, wherein the second subpanel extends along a second lateral plane;
a hinge assembly having a first section, a second section, and a third section between the first and second sections, wherein the first section is coupled to the first subpanel and the second section is coupled to the second subpanel to allow an angle between the first lateral plane and the second lateral plane to change; and
a power converter mounted on the first subpanel and electrically connected to the first and second set of PV cells.

14. The folding PV panel of claim 13, further comprising at least one electrical conductor extending from the first subpanel to the second subpanel, wherein the at least one electrical conductor is located in a cabling assembly bridging a channel defined by edges of the first and second subpanels and the third section of the hinge assembly, and wherein the power converter is electrically connected to the second set of PV cells via the at least one electrical conductor extending from the first subpanel to the second subpanel.

15. The folding PV panel of claim 14, further comprising a gap between the cabling assembly and the hinge assembly.

16. The folding PV panel of claim 14, wherein the hinge assembly comprises a first hinge assembly and the first and second sections of the first hinge assembly are coupled to a first side of the first subpanel and a first side of the second subpanel, respectively, and wherein the folding PV panel further comprises:
a second hinge assembly having a first section, a second section, and a third section between the first and second sections of the second hinge assembly, wherein the first and second sections of the second hinge assembly are coupled to a second side of the first subpanel and a second side of the second subpanel, respectively;
wherein the channel is defined by the third section of the first hinge assembly, the edges of the first and second subpanels, and the third section of the second hinge assembly.

17. The folding PV panel of claim 13, wherein the hinge assembly is foldable in a first configuration in which the first subpanel and the second subpanel form a stack, wherein in the stack a first side of the first subpanel faces a first side of the second subpanel, and a second configuration in which an edge of a second opposite side of the first subpanel overlaps an edge of the first side of the second subpanel.

18. The folding PV panel of claim 17, wherein, in the second configuration, an angle between the first section and the third section comprises an acute angle and an angle between the second section and the third section comprises an acute angle.

19. The folding PV panel of claim 17, wherein the first section of the hinge assembly is attached to the first subpanel differently than the second section of the hinge assembly is attached to the second subpanel.

20. A folding photovoltaic (PV) panel, comprising:
a first subpanel including a first set of PV cells between a first front sheet and a first back sheet, wherein the first subpanel extends along a first lateral plane;
a second subpanel including a second set of PV cells between a second front sheet and a second back sheet, wherein the second subpanel extends along a second lateral plane; and
a hinge assembly having a first section, a second section, and a third section between the first and second sections, wherein the first section is coupled to the first subpanel and the second section is coupled to the second subpanel to allow an angle between the first lateral plane and the second lateral plane to change
at least one electrical conductor extending from the first subpanel to the second subpanel, wherein the at least one electrical conductor is located in the hinge assembly bridging a channel defined by edges of the first and second subpanels and the third section of the hinge assembly;
an power converter mounted on the first subpanel and electrically connected to the first and second set of PV cells.
